(19) United States
(12) Patent Application Publication
(10) Pub. No.: US 2025/0315291 A1
(43) Pub. Date: Oct. 9, 2025

(54) ACTIVATION OF LAST FIBER FOR PARALLEL SUB-WAVE OPERATIONS

(71) Applicant: QUALCOMM Incorporated, San Diego, CA (US)

(72) Inventors: Andrew Evan GRUBER, Arlington, MA (US); Alexei Vladimirovich BOURD, San Diego, CA (US); Yan LI, San Diego, CA (US)

(21) Appl. No.: 18/628,631

(22) Filed: Apr. 5, 2024

(51) Int. Cl. G06F 9/48

(52) U.S. Cl. CPC G06F 9/4843

(57) ABSTRACT

Aspects presented herein relate to methods and devices for graphics processing including an apparatus, e.g., a GPU. The apparatus may allocate a wave into a set of sub-waves, where each sub-wave in the set of sub-waves comprises a set of threads. The apparatus may also perform a set of wave operations for each sub-wave in the set of sub-waves. Further, the apparatus may identify, based on the set of wave operations, a last active thread from amongst the set of threads for each sub-wave in the set of sub-waves.

### TECHNICAL FIELD

The present disclosure relates generally to processing systems and, more particularly, to one or more techniques for graphics processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor is configured to convert digital information received from a CPU to analog values and may issue commands to a display panel for displaying the visual content. A device that provides content for visual presentation on a display may utilize a GPU and/or a display processor.

A graphics processor of a device may be configured to perform the processes in a graphics processing pipeline. Further, graphics processors may utilize a number of different wave operations, such as sub-wave operations. However, there has developed a need for improved sub-wave operations.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a graphics processing unit (GPU), a central processing unit (CPU), or any apparatus that may perform for graphics processing. The apparatus may obtain an indication of a wave prior to an allocation of the wave into a set of sub-waves, where the allocation of the wave into the set of sub-waves is based on the obtained wave. The apparatus may also allocate a wave into a set of sub-waves, where each sub-wave in the set of sub-waves comprises a set of threads. The apparatus may also perform a set of wave operations for each sub-wave in the set of sub-waves. Additionally, the apparatus may identify, based on the set of wave operations, a last active thread from amongst the set of threads for each sub-wave in the set of sub-waves. The apparatus may also inactivate, based on the identification of the last active thread, one or more remaining threads in the set of threads for each sub-wave in the set of sub-waves, where the one or more remaining threads do not include the last active thread. Moreover, the apparatus may perform, based on the inactivation of the one or more remaining threads, a set of atomic operations via the last active thread for each sub-wave in the set of sub-waves. The apparatus may also reactivate, based on the performance of the set of atomic operations, the one or more remaining threads in the set of threads for each sub-wave in the set of sub-waves. The apparatus may also output an indication of the last active thread for each sub-wave in the set of sub-waves.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram that illustrates an example content generation system in accordance with one or more techniques of this disclosure.

FIG. 2 illustrates an example graphics processing unit (GPU) in accordance with one or more techniques of this disclosure.

FIG. 3 is a diagram illustrating example processing components in accordance with one or more techniques of this disclosure.

FIG. 4 is a diagram illustrating an example GPU hardware in accordance with one or more techniques of this disclosure.

FIG. 5 is a diagram illustrating an example GPU in accordance with one or more techniques of this disclosure.

FIG. 6 is a diagram illustrating an example GPU in accordance with one or more techniques of this disclosure.

FIG. 7 is a diagram illustrating an example GPU in accordance with one or more techniques of this disclosure.

FIG. 8 is a diagram illustrating an example wave operation in accordance with one or more techniques of this disclosure.

FIG. 9 is a diagram illustrating an example wave operation in accordance with one or more techniques of this disclosure.

FIG. 10 is a communication flow diagram illustrating example communications between a GPU, a GPU component, and a memory in accordance with one or more techniques of this disclosure.

FIG. 11 is a flowchart of an example method of graphics processing in accordance with one or more techniques of this disclosure.

FIG. 12 is a flowchart of an example method of graphics processing in accordance with one or more techniques of this disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOC), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software may be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise. The term application may refer to software. As described herein, one or more techniques may refer to an application, i.e., software, being configured to perform one or more functions. In such examples, the application may be stored on a memory, e.g., on-chip memory of a processor, system memory, or any other memory. Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

Accordingly, in one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that may be accessed by a computer. By way of example, and not limitation, such computer-readable media may comprise a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that may be used to store computer executable code in the form of instructions or data structures that may be accessed by a computer.

In general, this disclosure describes techniques for having a graphics processing pipeline in a single device or multiple devices, improving the rendering of graphical content, and/or reducing the load of a processing unit, i.e., any processing unit configured to perform one or more techniques described herein, such as a GPU. For example, this disclosure describes techniques for graphics processing in any device that utilizes graphics processing. Other example benefits are described throughout this disclosure.

As used herein, instances of the term “content” may refer to “graphical content,” “image,” and vice versa. This is true regardless of whether the terms are being used as an adjective, noun, or other parts of speech. In some examples, as used herein, the term “graphical content” may refer to a content produced by one or more processes of a graphics processing pipeline. In some examples, as used herein, the term “graphical content” may refer to a content produced by a processing unit configured to perform graphics processing. In some examples, as used herein, the term “graphical content” may refer to a content produced by a graphics processing unit.

In some examples, as used herein, the term “display content” may refer to content generated by a processing unit configured to perform displaying processing. In some examples, as used herein, the term “display content” may refer to content generated by a display processing unit. Graphical content may be processed to become display content. For example, a graphics processing unit may output graphical content, such as a frame, to a buffer (which may be referred to as a framebuffer). A display processing unit may read the graphical content, such as one or more frames from the buffer, and perform one or more display processing techniques thereon to generate display content. For example, a display processing unit may be configured to perform composition on one or more rendered layers to generate a frame. As another example, a display processing unit may be configured to compose, blend, or otherwise combine two or more layers together into a single frame. A display processing unit may be configured to perform scaling, e.g., upscaling or downscaling, on a frame. In some examples, a frame may refer to a layer. In other examples, a frame may refer to two or more layers that have already been blended together to form the frame, i.e., the frame includes two or more layers, and the frame that includes two or more layers may subsequently be blended.

Shader processors may help to execute a number of operations or instructions at a GPU (e.g., wave operations or sub-wave operations). In some aspects, sub-wave operations may be utilized as part of a full wave operation that is performed hierarchically (e.g., first 2 threads/fibers or combined, then 4 threads/fibers, then 8 threads/fibers, up to an entire wave). Also, sub-wave operations may be utilized as part of atomic operations or atomic increments. For example, for each thread/fiber there may be a number of individual atomic operations. Alternatively, a number of threads/fibers may be coalesced (e.g., 4 threads/fibers rather than performing an atomic increment) for a sub-wave operation. In some instances, sub-wave operations may be performed based on an optimal compromise between coalescing overhead and atomic operation overhead. Some types of wave communications or operations (e.g., GPU wave math communications and/or math operations) that are performed across threads/fibers within a wave (warp) may be standard and useful operations. One example of this is prefixed sum in which each thread/fiber may obtain the sum of all values of prior threads/fibers in a wave. For example, in a 4-wide wave, the fiber values may be: fiber 0=5, fiber 1=9, fiber 2=8, and fiber 3=10. The result of a prefixed sum (Prefix_Sum) operation may be: fiber 0=0, fiber 1=5, fiber 2=14, and fiber 3=22. However, it may be useful to divide up the wave into sub-waves and perform the operation across such sub-waves. For example, if the above wave is divided into subgroups (e.g., each subgroup of size 2), then the result of the Prefix_Sum operation may be: fiber 0=0, fiber 1=5, fiber 2=0, and fiber 3=14. Some implementations for full wave math operations may be implemented by combining the results of sub-wave operations. However, this may be performed in a serial manner and may not be as efficient as other approaches. Based on performing the above operations, it may be beneficial to have a mechanism to allow a representative fiber from each wave or sub-wave. That is, it may be beneficial to perform the aforementioned wave operations in a more efficient manner than a serial fashion. Aspects of the present disclosure may include a mechanism to identify or select a representative fiber from each sub-wave.

Aspects of the present disclosure may include a number of benefits or advantages. For instance, aspects of the present disclosure may perform a number of wave operations or sub-wave operations, then identify or select a representative fiber from each wave or sub-wave, and then allow the representative fiber from each sub-wave to work on a combined/final value from each sub-wave. That is, aspects presented herein may identify or select a thread/fiber within a particular sub-wave, and then activate the thread/fiber. The selected thread/fiber may also be used for a next hierarchical wave operation (e.g., a hierarchical coalescing operation). Aspects presented herein may also perform the aforementioned wave or sub-wave operations in a parallel manner. By performing the operations in a parallel manner, aspects of the present disclosure may perform the aforementioned wave or sub-wave operations in a more efficient way compared to other types of approaches (e.g., serial approaches). As such, aspects presented herein may reduce the amount of time and/or power at a GPU in order to perform the wave or sub-wave operations. Moreover, aspects presented herein may obtain a better clustered reduction support aligned with other application program interfaces (APIs). Also, aspects presented herein may obtain a performance improvement for certain types of operations (e.g., wave math based reduction operations). Aspects presented herein may also obtain a certain optimization (e.g., a uniform address atomics optimization) that can be performed at a cluster level.

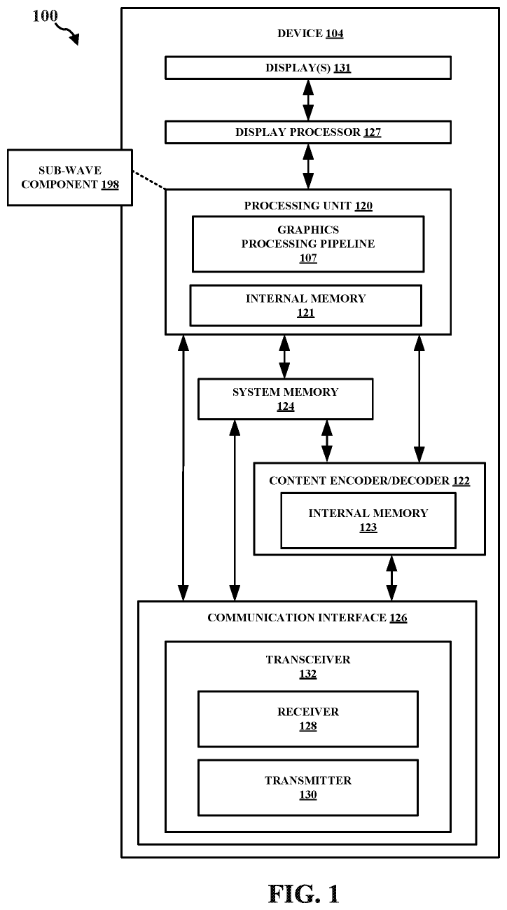

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of an SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components, e.g., a communication interface 126, a transceiver 132, a receiver 128, a transmitter 130, a display processor 127, and one or more displays 131. Reference to the display 131 may refer to the one or more displays 131. For example, the display 131 may include a single display or multiple displays. The display 131 may include a first display and a second display. The first display may be a left-eye display and the second display may be a right-eye display. In some examples, the first and second display may receive different frames for presentment thereon. In other examples, the first and second display may receive the same frames for presentment thereon. In further examples, the results of the graphics processing may not be displayed on the device, e.g., the first and second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing, such as in a graphics processing pipeline 107. The content encoder/decoder 122 may include an internal memory 123. In some examples, the device 104 may include a display processor, such as the display processor 127, to perform one or more display processing techniques on one or more frames generated by the processing unit 120 before presentment by the one or more displays 131. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of: a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 and the content encoder/decoder 122 may be communicatively coupled to the system memory 124 over a bus. In some examples, the processing unit 120 and the content encoder/decoder 122 may be communicatively coupled to each other over the bus or a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, SRAM, DRAM, erasable programmable ROM (EPROM), electrically erasable programmable ROM (EEPROM), flash memory, a magnetic data media or an optical storage media, or any other type of memory.

The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a central processing unit (CPU), a graphics processing unit (GPU), a general purpose GPU (GPGPU), or any other processing unit that may be configured to perform graphics processing. In some examples, the processing unit 120 may be integrated into a motherboard of the device 104. In some examples, the processing unit 120 may be present on a graphics card that is installed in a port in a motherboard of the device 104, or may be otherwise incorporated within a peripheral device configured to interoperate with the device 104. The processing unit 120 may include one or more processors, such as one or more microprocessors, GPUs, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit 120 may include a sub-wave component 198 configured to obtain an indication of a wave prior to an allocation of the wave into a set of sub-waves, where the allocation of the wave into the set of sub-waves is based on the obtained wave. The sub-wave component 198 may also be configured to allocate a wave into a set of sub-waves, where each sub-wave in the set of sub-waves comprises a set of threads. The sub-wave component 198 may also be configured to perform a set of wave operations for each sub-wave in the set of sub-waves. The sub-wave component 198 may also be configured to identify, based on the set of wave operations, a last active thread from amongst the set of threads for each sub-wave in the set of sub-waves. The sub-wave component 198 may also be configured to inactivate, based on the identification of the last active thread, one or more remaining threads in the set of threads for each sub-wave in the set of sub-waves, where the one or more remaining threads do not include the last active thread. The sub-wave component 198 may also be configured to perform, based on the inactivation of the one or more remaining threads, a set of atomic operations via the last active thread for each sub-wave in the set of sub-waves. The sub-wave component 198 may also be configured to reactivate, based on the performance of the set of atomic operations, the one or more remaining threads in the set of threads for each sub-wave in the set of sub-waves. The sub-wave component 198 may also be configured to output an indication of the last active thread for each sub-wave in the set of sub-waves. Although the following description may be focused on graphics processing, the concepts described herein may be applicable to other similar processing techniques.

As described herein, a device, such as the device 104, may refer to any device, apparatus, or system configured to perform one or more techniques described herein. For example, a device may be a server, a base station, user equipment, a client device, a station, an access point, a computer, e.g., a personal computer, a desktop computer, a laptop computer, a tablet computer, a computer workstation, or a mainframe computer, an end product, an apparatus, a phone, a smart phone, a server, a video game platform or console, a handheld device, e.g., a portable video game device or a personal digital assistant (PDA), a wearable computing device, e.g., a smart watch, an augmented reality device, or a virtual reality device, a non-wearable device, a display or display device, a television, a television set-top box, an intermediate network device, a digital media player, a video streaming device, a content streaming device, an in-car computer, any mobile device, any device configured to generate graphical content, or any device configured to perform one or more techniques described herein. Processes herein may be described as performed by a particular component (e.g., a GPU), but, in further embodiments, may be performed using other components (e.g., a CPU), consistent with disclosed embodiments.

GPUs may process multiple types of data or data packets in a GPU pipeline. For instance, in some aspects, a GPU may process two types of data or data packets, e.g., context register packets and draw call data. A context register packet may be a set of global state information, e.g., information regarding a global register, shading program, or constant data, which may regulate how a graphics context will be processed. For example, context register packets may include information regarding a color format. In some aspects of context register packets, there may be a bit that indicates which workload belongs to a context register. Also, there may be multiple functions or programming running at the same time and/or in parallel. For example, functions or programming may describe a certain operation, e.g., the color mode or color format. Accordingly, a context register may define multiple states of a GPU.

Context states may be utilized to determine how an individual processing unit functions, e.g., a vertex fetcher (VFD), a vertex shader (VS), a shader processor, or a geometry processor, and/or in what mode the processing unit functions. In order to do so, GPUs may use context registers and programming data. In some aspects, a GPU may generate a workload, e.g., a vertex or pixel workload, in the pipeline based on the context register definition of a mode or state. Certain processing units, e.g., a VFD, may use these states to determine certain functions, e.g., how a vertex is assembled. As these modes or states may change, GPUs may need to change the corresponding context. Additionally, the workload that corresponds to the mode or state may follow the changing mode or state.

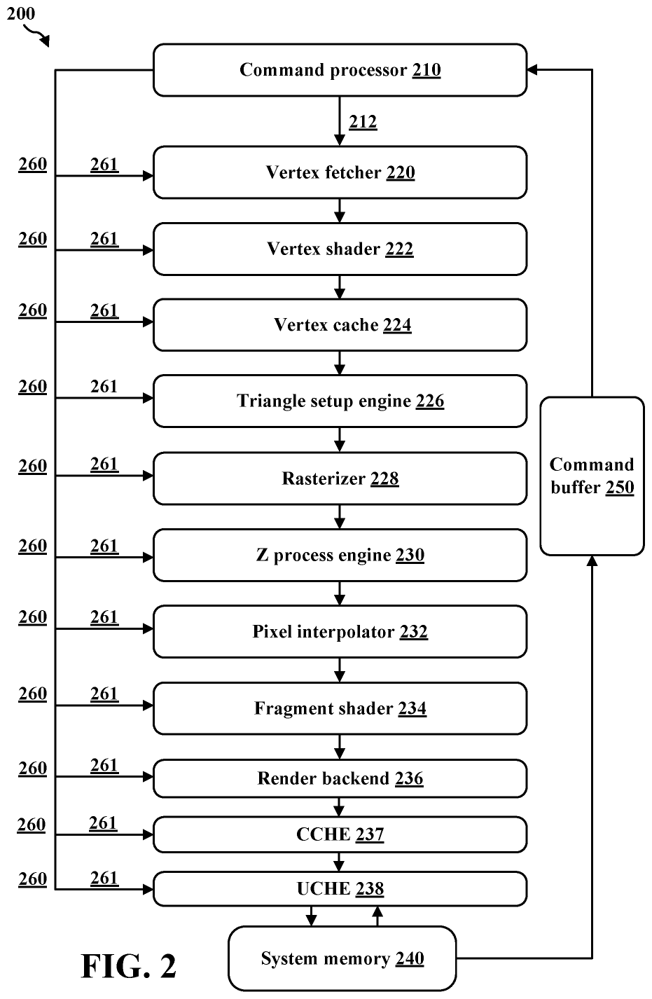

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, level 1 (L1) cache (cluster cache (CCHE)) 237, level 2 (L2) cache (UCHE) 238, and system memory 240. Although FIG. 2 displays that GPU 200 includes processing units 220-238, GPU 200 may include a number of additional processing units. Additionally, processing units 220-238 are merely an example and any combination or order of processing units may be used by GPUs according to the present disclosure. GPU 200 also includes command buffer 250, context register packets 260, and context states 261.

As shown in FIG. 2, a GPU may utilize a CP, e.g., CP 210, or hardware accelerator to parse a command buffer into context register packets, e.g., context register packets 260, and/or draw call data packets, e.g., draw call packets 212. The CP 210 may then send the context register packets 260 or draw call packets 212 through separate paths to the processing units or blocks in the GPU. Further, the command buffer 250 may alternate different states of context registers and draw calls. For example, a command buffer may be structured in the following manner: context register of context N, draw call(s) of context N, context register of context N+1, and draw call(s) of context N+1.

GPUs may render images in a variety of different ways. In some instances, GPUs may render an image using rendering and/or tiled rendering. In tiled rendering GPUs, an image may be divided or separated into different sections or tiles. After the division of the image, each section or tile may be rendered separately. Tiled rendering GPUs may divide computer graphics images into a grid format, such that each portion of the grid, i.e., a tile, is separately rendered. In some aspects, during a binning pass, an image may be divided into different bins or tiles. In some aspects, during the binning pass, a visibility stream may be constructed where visible primitives or draw calls may be identified. In contrast to tiled rendering, direct rendering does not divide the frame into smaller bins or tiles. Rather, in direct rendering, the entire frame is rendered at a single time. Additionally, some types of GPUs may allow for both tiled rendering and direct rendering.

Instructions executed by a CPU (e.g., software instructions) or a display processor may cause the CPU or the display processor to search for and/or generate a composition strategy for composing a frame based on a dynamic priority and runtime statistics associated with one or more composition strategy groups. A frame to be displayed by a physical display device, such as a display panel, may include a plurality of layers. Also, composition of the frame may be based on combining the plurality of layers into the frame (e.g., based on a frame buffer). After the plurality of layers are combined into the frame, the frame may be provided to the display panel for display thereon. The process of combining each of the plurality of layers into the frame may be referred to as composition, frame composition, a composition procedure, a composition process, or the like.

A frame composition procedure or composition strategy may correspond to a technique for composing different layers of the plurality of layers into a single frame. The plurality of layers may be stored in doubled data rate (DDR) memory. Each layer of the plurality of layers may further correspond to a separate buffer. A composer or hardware composer (HWC) associated with a block or function may determine an input of each layer/buffer and perform the frame composition procedure to generate an output indicative of a composed frame. That is, the input may be the layers and the output may be a frame composition procedure for composing the frame to be displayed on the display panel.

Some types of GPUs may include different types of pipelines, such as a graphics processing pipeline. Graphics processing pipelines may include one or more of a vertex shader stage, a hull shader stage, a domain shader stage, a geometry shader stage, and a pixel shader stage. These stages of the graphics processing pipeline may be considered shader stages. These shader stages may be implemented as one or more shader programs that execute on shader units at a GPU. Shader units may be configured as a programmable pipeline of processing components. In some examples, a shader unit may be referred to as “shader processors” or “unified shaders,” and may perform geometry, vertex, pixel, or other shading operations to render graphics. Shader units may include shader processors, each of which may include one or more components for fetching and decoding operations, one or more arithmetic logic units (ALUs) for carrying out arithmetic calculations, one or more memories, caches, and registers.

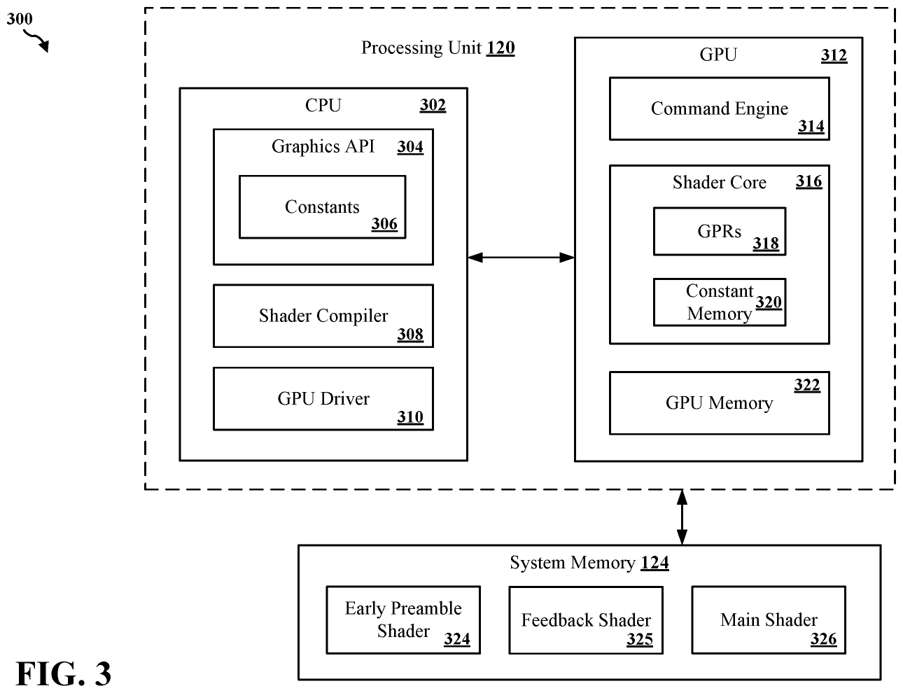

FIG. 3 is a diagram 300 that illustrates processing components, such as the processing unit 120 and the system memory 124, as may be identified in connection with the device 104 for processing data. In aspects, the processing unit 120 may include a CPU 302 and a GPU 312. The GPU 312 and the CPU 302 may be formed as an integrated circuit (e.g., a system-on-a-chip (SOC)) and/or the GPU 312 may be incorporated onto a motherboard with the CPU 302. Alternatively, the CPU 302 and the GPU 312 may be configured as distinct processing units that are communicatively coupled to each other. For example, the GPU 312 may be incorporated on a graphics card that is installed in a port of the motherboard that includes the CPU 302.

The CPU 302 may be configured to execute a software application that causes graphical content to be displayed (e.g., on the display(s) 131 of the device 104) based on one or more operations of the GPU 312. The software application may issue instructions to a graphics application program interface (API) 304, which may be a runtime program that translates instructions received from the software application into a format that is readable by a GPU driver 310. After receiving instructions from the software application via the graphics API 304, the GPU driver 310 may control an operation of the GPU 312 based on the instructions. For example, the GPU driver 310 may generate one or more command streams that are placed into the system memory 124, where the GPU 312 is instructed to execute the command streams (e.g., via one or more system calls). A command engine 314 included in the GPU 312 is configured to retrieve the one or more commands stored in the command streams. The command engine 314 may provide commands from the command stream for execution by the GPU 312. The command engine 314 may be hardware of the GPU 312, software/firmware executing on the GPU 312, or a combination thereof. While the GPU driver 310 is configured to implement the graphics API 304, the GPU driver 310 is not limited to being configured in accordance with any particular API. The system memory 124 may store the code for the GPU driver 310, which the CPU 302 may retrieve for execution. In examples, the GPU driver 310 may be configured to allow communication between the CPU 302 and the GPU 312, such as when the CPU 302 offloads graphics or non-graphics processing tasks to the GPU 312 via the GPU driver 310.

The system memory 124 may further store source code for one or more of an early preamble shader 324, a feedback shader 325, or a main shader 326. In such configurations, a shader compiler 308 executing on the CPU 302 may compile the source code of the shaders 324-326 to create object code or intermediate code executable by a shader core 316 of the GPU 312 during runtime (e.g., at the time when the shaders 324-326 are to be executed on the shader core 316). In some examples, the shader compiler 308 may pre-compile the shaders 324-326 and store the object code or intermediate code of the shader programs in the system memory 124. The shader compiler 308 (or in another example the GPU driver 310) executing on the CPU 302 may build a shader program with multiple components including the early preamble shader 324, the feedback shader 325, and the main shader 326. The main shader 326 may correspond to a portion or the entirety of the shader program that does not include the early preamble shader 324 or the feedback shader 325. The shader compiler 308 may receive instructions to compile the shader(s) 324-326 from a program executing on the CPU 302. The shader compiler 308 may also identify constant load instructions and common operations in the shader program for including the common operations within the early preamble shader 324 (rather than the main shader 326). The shader compiler 308 may identify such common instructions, for example, based on (presently undetermined) constants 306 to be included in the common instructions. The constants 306 may be defined within the graphics API 304 to be constant across an entire draw call. The shader compiler 308 may utilize instructions such as a preamble shader start to indicate a beginning of the early preamble shader 324 and a preamble shader end to indicate an end of the early preamble shader 324. Similar instructions may be used for the feedback shader 325 and the main shader 326. The feedback shader 325 will be described in further detail below.

The shader core 316 included in the GPU 312 may include general purpose registers (GPRs) 318 and constant memory 320. The GPRs 318 may correspond to a single GPR, a GPR file, and/or a GPR bank. Each GPR in the GPRs 318 may store data accessible to a single thread. The software and/or firmware executing on GPU 312 may be a shader program 324-326, which may execute on the shader core 316 of GPU 312. The shader core 316 may be configured to execute many instances of the same instructions of the same shader program in parallel. For example, the shader core 316 may execute the main shader 326 for each pixel that defines a given shape. The shader core 316 may transmit and receive data from applications executing on the CPU 302. In examples, constants 306 used for execution of the shaders 324-326 may be stored in a constant memory 320 (e.g., a read/write constant RAM) or the GPRs 318. The shader core 316 may load the constants 306 into the constant memory 320. In further examples, execution of the early preamble shader 324 or the feedback shader 325 may cause a constant value or a set of constant values to be stored in on-chip memory such as the constant memory 320 (e.g., constant RAM), the GPU memory 322, or the system memory 124. The constant memory 320 may include memory accessible by all aspects of the shader core 316 rather than just a particular portion reserved for a particular thread such as values held in the GPRs 318.

In some aspects, different types of GPU hardware may support different types of workload execution. For instance, GPU hardware may support concurrent execution of different workloads. Concurrent execution may refer to the simultaneous execution of workloads at a GPU. Also, concurrent execution may refer to the execution of workloads in parallel at a GPU. GPU hardware may also support concurrent execution of different workloads in a time-shared manner. In some instances, concurrent execution of different workloads in a time-shared manner may improve the performance per area at the GPU. However, in other instances, concurrent execution of different workloads in a time-shared manner may reduce the performance per area at the GPU. Additionally, different types of workloads may take a different amount of processing time in various stages of the GPU pipeline. Also, these types of workloads may introduce inefficiency in GPU hardware utilization.

In some aspects, scheduling algorithms in order to time-share the GPU hardware may sequence the workload to achieve the best utilization of GPU hardware. However, some types of workloads may block the execution of other successive workloads. For instance, some workloads with a higher specification for a resource (e.g., memory access latency) may block the execution of other successive workloads, which may have reduced resource specification and a faster execution time (e.g., head of line blocking). In turn, this may reduce the overall hardware efficiency at the GPU. This kind of workload pattern is common in certain types of binning (e.g., concurrent binning). For example, in concurrent binning, a tile sorting pass for a certain frame (e.g., frame ‘N+1’) may be run concurrently with a rendering pass of another frame (e.g., frame ‘N’).

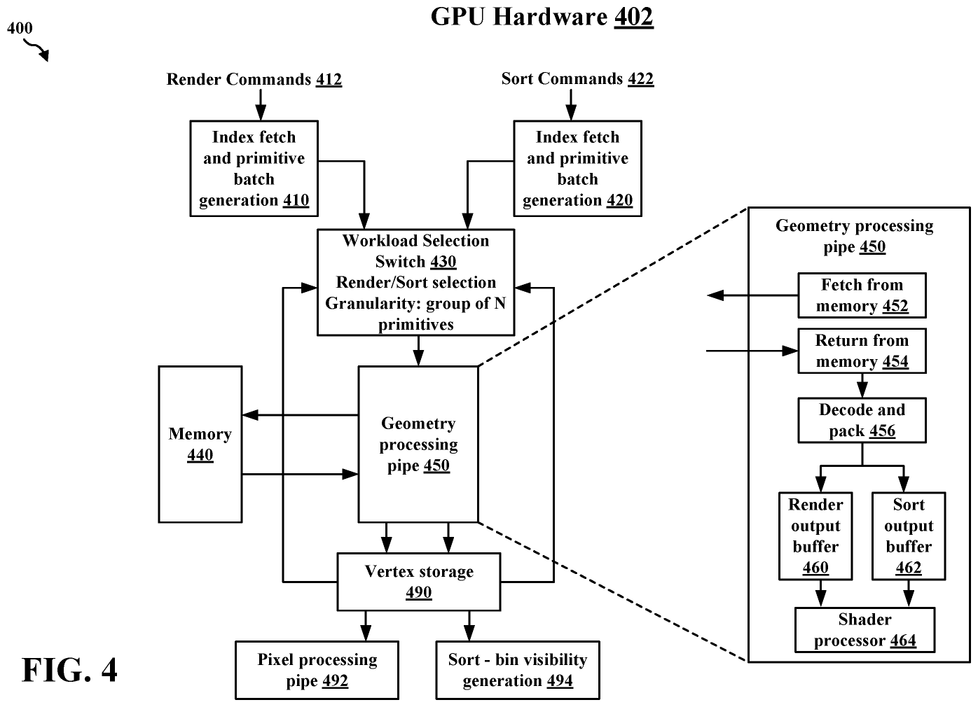

FIG. 4 illustrates diagram 400 including one example of GPU hardware. More specifically, diagram 400 depicts a time-shared GPU hardware for concurrent binning. As shown in FIG. 4, diagram 400 includes GPU hardware 402 including index fetch and primitive batch generation component 410, index fetch and primitive batch generation component 420, software 430, memory 440, geometry processing pipe 450, vertex storage component 490, pixel processing pipe 492, and sort-bin visibility generation component 494. As shown in FIG. 4, render commands 412 may be input to index fetch and primitive batch generation component 410, which may be output to software 430. Similarly, sort commands 422 may be input to index fetch and primitive batch generation component 420, which may be output to software 430. The software 430 may have a render/sort selection capability, as well as a certain granularity (e.g., a granularity for a group of N primitives). The output of software 430 may be sent to geometry processing pipe 450, which may communicate with memory 440. The geometry processing pipe 450 may include fetch from memory component 452, return from memory component 454, decode and pack component 456, render output buffer 460, sort output buffer 462, and shader processor 464. Also, the output of geometry processing pipe 450 may be sent to vertex storage component 490, which may be sent to pixel processing pipe 492 and sort-bin visibility generation component 494.

As shown in FIG. 4, geometry pipe hardware (e.g., geometry processing pipe 450) may be time shared between tile sorting and tile render workloads. Also, a scheduling algorithm (e.g., software 430) may consider the availability of GPU hardware for tile sorting and tile render workload. The granularity of a workload may be selected such that there is limited workload switching overhead. Further, the granularity of a workload may be selected such that, at the same time, one workload does not block the other. As shown in FIG. 4, the software 430 may have a granularity of a group of N primitives. For instance, for concurrent binning, the workload distribution granularity may be a primitive batch (e.g., a set of N primitives).

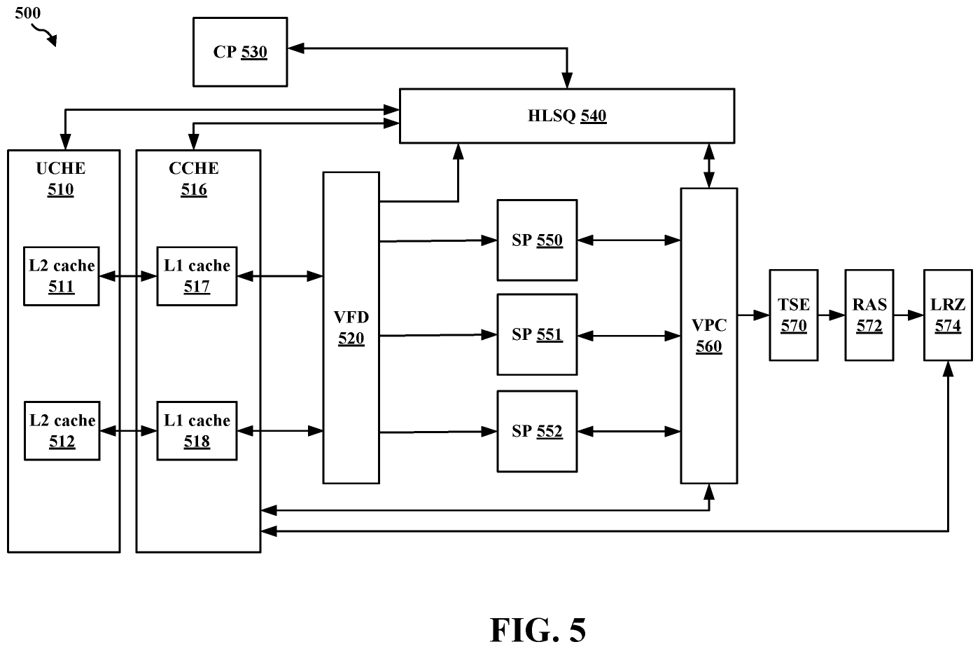

FIG. 5 is a diagram illustrating another example GPU. More specifically, FIG. 5 depicts GPU 500 including a number of different components. As shown in FIG. 5, GPU 500 includes UCHE 510 including L2 cache 511 and L2 cache 512, CCHE 516 including L1 cache 517 and L1 cache 518, VFD 520, CP 530, HLSQ 540, a number of SPs (e.g., SP 550, SP 551, and SP 552), VPC 560, TSE 570, RAS 572, and low resolution Z (LRZ) component (e.g., LRZ 574). As shown in FIG. 5, CP 530 may transmit data to HLSQ 540 and receive data from HLSQ 540. CCHE 516 may transmit/receive data to/from HLSQ 540. UCHE 510 may also transmit/receive data to/from HLSQ 540. L2 cache 511 and L2 cache 512 may transmit/receive data to/from VFD 520. Further, VFD 520 may transmit data to HLSQ 540, as well as transmit data to SPs 550-552. Moreover, SPs 550-552 may transmit/receive data to/from VPC 560. Also, VPC 560 may transmit/receive data to/from HLSQ 540. Data can also be transmitted from VPC 560 to TSE 570, which can transmit data to RAS 572, and then to LRZ 574. CCHE 516 can transmit/receive data to/from VPC 560 and LRZ 574. Also, UCHE 510 can transmit/receive data to/from VPC 560 and LRZ 574.

Some aspects of graphics processing may utilize certain GPU architectures and/or application structures. For instance, aspects of graphics processing may utilize a general purpose GPU (GPGPU) architecture that includes symmetric multiprocessor (SMs), shared cores, an interconnect unit, a dynamic random access memory (DRAM), and/or a number of different caches (e.g., a first level (L1) cache, a second level (L2) cache, and/or a last level cache (LLC)). In some instances of GPU architectures, a number of SMs, shared cores, and L1 caches may be connected to an interconnect unit. The interconnect unit may be connected to L2 caches and DRAMs. Additionally, in an application structure, an application may include a number of kernels, and each of the kernels may include concurrent thread arrays (CTAs), where each CTA includes a number of warps.

As indicated herein, a kernel may be a programming operations manager or a programming thread at a GPU. Also, a kernel may be executed in parallel by an array of threads, where all threads may run the same code. Each thread may have an identifier (ID) that it uses to compute memory addresses and make control decisions. A warp may be a collection of threads (e.g., 32 threads) that are executed simultaneously by a symmetric multiprocessor (SM). A warp may be a basic unit of execution, where multiple warps may be executed on an SM at once. When a program on a CPU invokes a kernel grid, the blocks of the grid may be enumerated and distributed to SMs with available execution capacity. The threads of a thread block may execute concurrently on one SM, and multiple thread blocks may execute concurrently on one SM. As thread blocks terminate, new blocks are launched on the vacated SMs. The mapping between warps and thread blocks may affect the performance of the kernel. Also, a clock or GPU clock may be a logical beat or time that is used to synchronize actions of the GPU. A clock source may manage how a GPU component derives its clock. A symmetric multiprocessor (SM) may be single instruction multiple thread processor which has multiple shared cores (e.g., shader processors (SPs)) for integer processing, special functional units (SFUs) (e.g., for calculating functions such as sine, cosine, root mean-squared (RMS), etc.). The SM may have load store (LD/ST) units for load and store into memory/registers. The SM may also have L1 caches, shared caches and large-banked register files. A concurrent thread array (CTA) may be a basic workload unit assigned to an SM in a GPU. Threads in a CTA may be sub-grouped into a warp/wavefronts, which is the smallest execution unit sharing the same program counter. A last level cache (LLC) may be a last level of cache from a GPUs context, such as an extended cache for SMs. An interconnect unit may be a crossbar switch which does multi-master arbitration, by which GPUs are connected to rest of the world. Further, a pointer of serialization/pointer of coherence (PoS/PoC) may be point in the system-on-chip (SoC) post where every master in the system may see the same coherent copy of data.

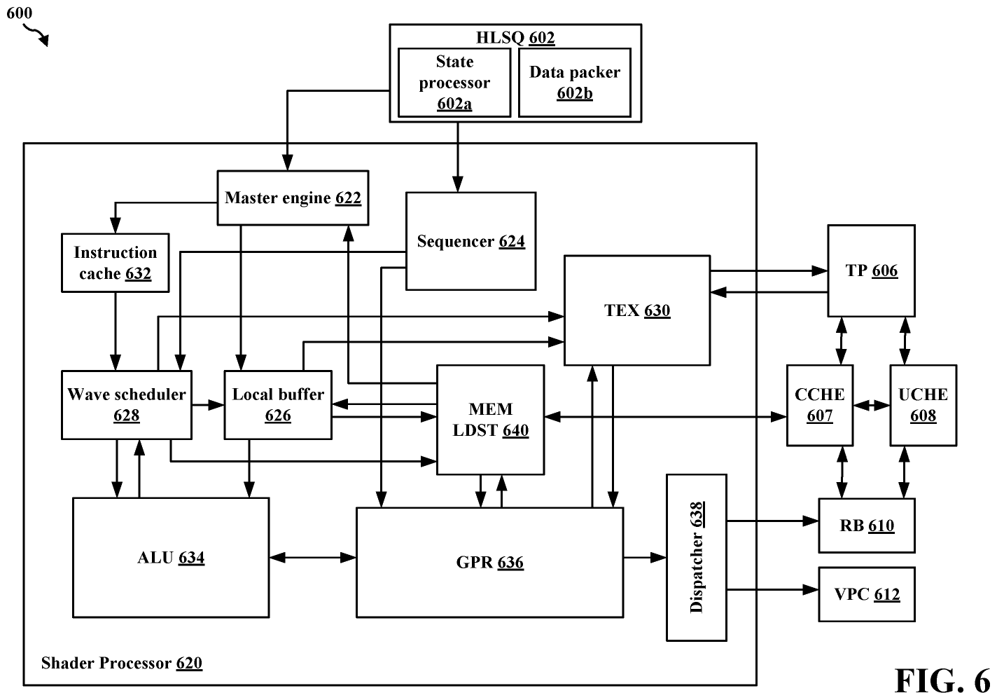

FIG. 6 illustrates an example GPU 600. Specifically, FIG. 6 illustrates a shader processor (SP) system in GPU 600. As shown in FIG. 6, GPU 600 includes a high level sequencer (HLSQ) 602, texture processor (TP) 606, level 1 (L1) cache (cluster cache (CCHE)) 607, level 2 (L2) cache (UCHE) 608, render backend (RB) 610, and vertex cache (VPC) 612. GPU 600 also includes SP 620, master engine 622, sequencer 624, local buffer 626, wave scheduler 628, texture (TEX) 630, instruction cache 632, arithmetic logic unit (ALU) 634, GPR 636, dispatcher 638, and memory (MEM) load store (LDST) 640.

As shown in FIG. 6, each unit or block in GPU 600 may send data or information to other blocks. For instance, HLSQ 602 may send commands to the master engine 622. Also, HLSQ 602 may send vertex threads, vertex attributes, pixel threads, pixel attributes, and/or compute commands to the sequencer 624. TP 606 may receive texture requests from TEX 630, and send texture elements (texels) back to the TEX 630. Further, TP 606 may send memory read requests to and receive memory data from CCHE 607 or UCHE 608. CCHE 607 or UCHE 608 may also receive memory read or write requests from MEM LDST 640 and send memory data back to MEM LDST 640, as well as receive memory read or write requests from RB 610 and send memory data back to RB 610. Also, RB 610 may receive an output in the form of color from GPR 636, e.g., via dispatcher 638. VPC 612 may also receive output in the form of vertices from GPR 636, e.g., via dispatcher 638. GPR 636 may send address data or receive write back data from MEM LDST 640. GPR 636 may also send temporary data to and receive temporary data from ALU 634. Moreover, ALU 634 may send address or predicate information to the wave scheduler 628, as well as receive instructions from wave scheduler 628. Local buffer 626 may send constant data to ALU 634. TEX 630 may also receive texture attributes from or send texture data to GPR 636, as well as receive constant data from local buffer 626. Further, TEX 630 may receive texture requests from wave scheduler 628, as well as receive constant data from local buffer 626. MEM LDST 640 may send/receive constant data to/from local buffer 626. Sequencer 624 may send wave data to wave scheduler 628, as well as send data to GPR 636. The sequencer 624 may allocate resources and local memory. Also, the sequencer 624 may allocate wave slots and any associated GPR 636 space. For example, the sequencer 624 may allocate wave slots or GPR 636 space when the HLSQ 602 issues a pixel tile workload to the SP 620. Master engine 622 may send program data to instruction cache 632, as well as send constant data to local buffer 626 and receive instructions from MEM LDST 640. Instruction cache 632 may send instructions or decode information to wave scheduler 628. Wave scheduler 628 may send read requests to local buffer 626, as well as send memory requests to MEM LDST 640.

As further shown in FIG. 6, the HLSQ 602 may prepare one or more context states for the SP 620. For example, the HLSQ 602 may prepare the context states for different types of data, e.g., global register data, shader constant data, buffer descriptors, instructions, etc. Additionally, the HLSQ 602 may embed context states into a command stream to the SP 620. The master engine 622 may parse the command stream from the HLSQ 602 and setup an SP global state. Moreover, the master engine 622 may fill or add to an instruction cache 632 and/or a local buffer 626 or a constant buffer. In some aspects, inside the HLSQ 602, there may be an internal function unit called a state processor 602a. The state processor 602a may be a single fiber scalar processor that may execute a special shader program, e.g., a preamble shader. The preamble shader may be generated by the GPU compiler in order to load constant data from different buffer objects. Also, the preamble shader may bind the buffer objects into a single constant buffer, such as a post-process constant buffer. Further, the HLSQ 602 may execute the preamble shader and, as a result, skip utilizing a main shader. In some instances, the main shader may perform different shading tasks, such as normal vertex shading and/or a fragment shading program. Moreover, the HLSQ 602 may include a data packer 602b.

Additionally, as shown in FIG. 6, the SP 620 may not be limited to executing a preamble if the HLSQ 602 decides to skip a preamble execution. For instance, the SP 620 may also process a conventional graphics workload, such as vertex shading and/or fragment shading. In some aspects, the SP 620 may utilize its execution units and storage in order to process compute tasks as a general purpose GPU (GPGPU). Inside the SP 620, there may be multiple parallel instruction execution units such as an ALU, elementary function unit (EFU), branching unit, TEX, general memory read and write (aka LDST), etc. The SP 620 may also include on-chip storage memory, such as a GPR 636 which may store per-fiber private data. Also, the SP 620 may include a local buffer 626 which stores per-shader or per-kernel constant data, per-wave uniform data (aka uGPR), and per-compute work group (WG) local memory (LM). Processing a preamble shader may take up one wave slot. Further, the majority of preamble shaders may use just the uGPR and not the GPR, and may execute ALU instructions on a scalar ALU. Therefore, execution of the preamble shader may be associated with high performance, and may be power efficient because any available wave slot may be used to execute the preamble shader even without GPR space allocation.

Moreover, as shown in FIG. 6, dispatcher 638 may fetch data from GPR 636. Dispatcher 638 may also perform format conversion, and then dispatch a final color to multiple render targets (RTs). Each RT may have one or more components, such as red (r) green (G) blue (B) alpha (A) (RGBA) data, or just an alpha component of the RGBA data. Further, each RT may be generally stored in a vector GPR, i.e., R3.0 may store red data, R3.1 may store green data, R3.2 may store blue data, etc. Also, a driver program in an SP context register may be utilized to define the GPR identifier (ID) which stores RT data.

As indicated herein, graphics processors (e.g., GPUs) may work in a single instruction, multiple data (SIMD) fashion. GPUs may process certain types of instructions that are associated with the SIMD operation. For instance, a GPU may process wave instructions or waves, which are the width of data elements that are operated on by a single instruction associated with the SIMD. The term wave may also refer to a set of threads or blocks that run concurrently on the GPU. Waves may be allocated into sub-waves, which may include a number of threads or fibers. An active thread/fiber may refer to a thread/fiber that executes instructions (e.g., instructions in the ALU). An inactive thread/fiber may refer to a thread/fiber that does not execute instructions. Threads/fibers that do not partake in a branching operation may eventually become inactive (i.e., partake in the next level of the hierarchy). A kernel may be a programming operations manager or a programming thread at a GPU. Also, a kernel may be executed in parallel by an array of threads/fibers, where all threads/fibers may run the same code. Each thread/fiber may have an identifier (ID) that it uses to compute memory addresses and make control decisions. GPUs may also process a number of different operations, such as an atomic operation. An atomic operation may enable another operation (e.g., a read-modify-write operation or a read-write operation) to occur without any interruption. As such, an atomic operation may assure that no other execution operation at a GPU may have been inserted between the target operation (e.g., a read-modify-write operation or a read-write operation).

In some aspects, a shader in the context of a graphics processor (e.g., a GPU) may be a program that is used to control the rendering effects of 3D computer graphics. There are different types of shaders (e.g., vertex shaders, pixel shaders, and geometry shaders), each of which may handle a different aspect of the rendering process. Shaders may be used to produce realistic lighting, shadows, textures, and other visual effects in video games, simulations, and other 3D applications. A shader processor (SP) may utilize one or more context states to perform various operations and calculations. For instance, a shader processor may be part of multiple shared cores for integer processing. Also, a shader processor may execute shader code (e.g., vertex shaders, fragment shaders, compute shaders, etc.). The shader processor may also be referred to as a shader core. Shader code may also be referred to as a shader and may refer to a user-defined program configured to run in a stage of the GPU. In an example, the shader code may be associated with the rendering of graphical content. The shader processor may include a number of different components, such as arithmetic logic units (ALUs) and general purpose registers (GPRs). An ALU may be a combinatorial digital circuit that performs arithmetic and bitwise operations on integer binary numbers (e.g., a signed integer, an unsigned integer, etc.). A GPR may be a register that stores both data and addresses, that is, the GPR may be a combined data/address register. A register may refer to a location that may be accessed by a processor. A register may include a small amount of relatively quickly accessible storage.

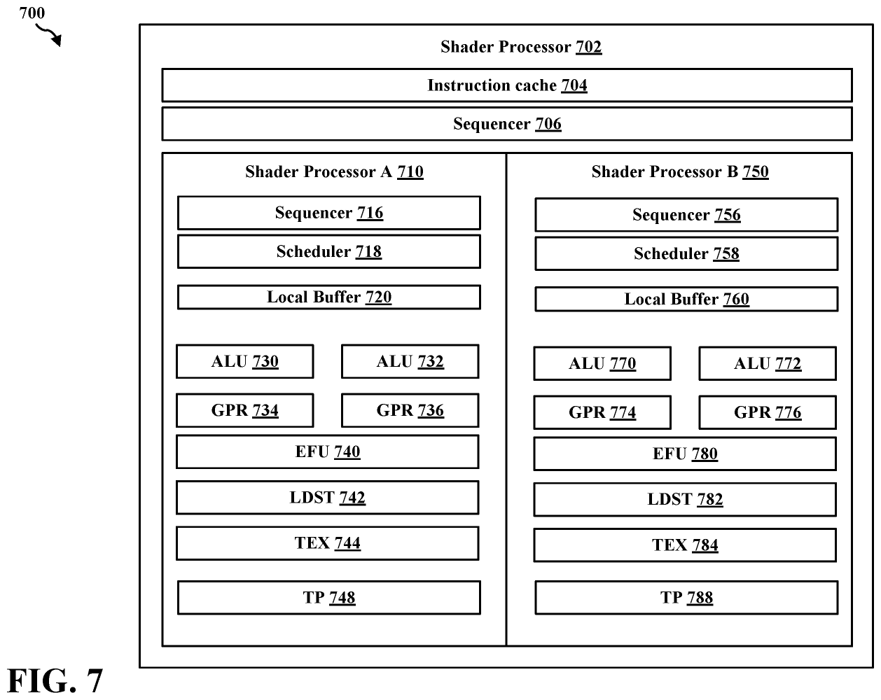

FIG. 7 illustrates diagram 700 including one example of a GPU. More specifically, diagram 700 depicts one example of a shader processor (SP) at a GPU. As shown in FIG. 7, diagram 700 includes shader processor 702 including instruction cache 704, sequencer 706, as well as shader processor A 710 and shader processor B 750. Shader processor A 710 includes sequencer 716, scheduler 718 (e.g., a wave scheduler), local buffer 720, a number of arithmetic logic units (ALUs) including ALU 730 (e.g., 64 ALUs) and ALU 732 (e.g., 64 ALUs), a number of general purpose registers (GPRs) including GPR 734 and GPR 736, elementary function unit (EFU) 740 (e.g., 16 EFUs), load store (LDST) 742, texture (TEX) 744, and texture processor (TP) 748. Shader processor B 750 includes sequencer 756, scheduler 758 (e.g., a wave scheduler), local buffer 760, a number of arithmetic logic units (ALUs) including ALU 770 (e.g., 64 ALUs) and ALU 772 (e.g., 64 ALUs), a number of general purpose register (GPR) including GPR 774 and GPR 776, elementary function unit (EFU) 780 (e.g., 16 EFUs), load store (LDST) 782, texture (TEX) 784, and texture processor (TP) 788. FIG. 7 depicts that shader processors can be divided into multiple, smaller shader processors. All shader processors may execute various types of shader code (e.g., vertex shaders, fragment shaders, compute shaders, etc.).

As shown in FIG. 7, each of the components in shader processor 702 may perform a number of different operations. For instance, the TP 748 may receive texture requests from TEX 744, and send texture elements (texels) back to the TEX 744. Likewise, TP 788 may receive texture requests from TEX 784, and send texture elements (texels) back to the TEX 784. GPR 734/736 may send address data or receive write back data from LDST 742. Likewise, GPR 774/776 may send address data or receive write back data from LDST 782. GPR 734/736 may also send temporary data to and receive temporary data from ALU 730/732. Likewise, GPR 774/776 may also send temporary data to and receive temporary data from ALU 770/772. Moreover, ALU 730/732 may send address or predicate information to the scheduler 718, as well as receive instructions from scheduler 718. Likewise, ALU 770/772 may send address or predicate information to the scheduler 758, as well as receive instructions from scheduler 758. Local buffer 720 may send constant data to ALU 730/732 and local buffer 760 may send constant data to ALU 770/772. TEX 744 may also receive texture attributes from or send texture data to GPR 734/736, as well as receive constant data from local buffer 720. Likewise, TEX 784 may also receive texture attributes from or send texture data to GPR 774/776, as well as receive constant data from local buffer 760. Further, TEX 744 may receive texture requests from scheduler 718, as well as receive constant data from local buffer 720. Likewise, TEX 784 may receive texture requests from scheduler 758, as well as receive constant data from local buffer 760. LDST 742 may send/receive constant data to/from local buffer 720 and LDST 782 may send/receive constant data to/from local buffer 760. Sequencer 716 may send wave data to scheduler 718, as well as send data to GPR 734/736. Likewise, sequencer 756 may send wave data to scheduler 758, as well as send data to GPR 774/776. The sequencer 716 may also allocate resources to local buffer 720 and the sequencer 756 may also allocate resources to local buffer 760.

Shader processors may help to execute a number of operations or instructions at a GPU (e.g., wave operations or sub-wave operations). In some aspects, sub-wave operations may be utilized as part of a full wave operation that is performed hierarchically (e.g., first 2 threads/fibers or combined, then 4 threads/fibers, then 8 threads/fibers, up to an entire wave). Also, sub-wave operations may be utilized as part of atomic operations or atomic increments. For example, for each wave there may be a number of individual atomic operations (one per active fiber). Alternatively, a number of threads/fibers may be coalesced for a sub-wave operation (e.g., rather than each sub-wave of 4 threads/fibers performing four atomic increments, instead performing a single atomic ADD of ‘4’ using one of the fibers within the sub-wave). In some instances, sub-wave operations may be performed based on an optimal compromise between coalescing overhead and atomic operation overhead.

Some types of wave communications or operations (e.g., GPU wave math communications and/or math operations) that are performed across threads/fibers within a wave (warp) may be standard and useful operations. One example of this is prefixed sum in which each thread/fiber may obtain the sum of all values of prior threads/fibers in a wave. For example, in a 4-wide wave, the fiber values may be: fiber 0=5, fiber 1=9, fiber 2=8, and fiber 3=10. The result of a prefixed sum (Prefix_Sum) operation may be: fiber 0=0, fiber 1=5, fiber 2=14, and fiber 3=22. However, it may be useful to divide up the wave into sub-waves and perform the operation across such sub-waves. For example, if the above wave is divided into subgroups (e.g., each subgroup of size 2), then the result of the Prefix_Sum operation may be: fiber 0=0, fiber 1=5, fiber 2=0, and fiber 3=14. Some implementations for full wave math operations may be implemented by combining the results of sub-wave operations. However, this may be performed in a serial manner and may not be as efficient as other approaches. Based on performing the above operations, it may be beneficial to have a mechanism to allow a representative fiber from each wave or sub-wave. That is, it may be beneficial to perform the aforementioned wave operations in a more efficient manner than a serial fashion.

Aspects of the present disclosure may include a mechanism to identify or select a representative fiber from each sub-wave. For instance, aspects of the present disclosure may perform a number of wave operations or sub-wave operations, then identify or select a representative fiber from each wave or sub-wave, and then allow the representative fiber from each sub-wave to work on a combined/final value from each sub-wave. That is, aspects presented herein may identify or select a thread/fiber within a particular sub-wave, and then activate the thread/fiber. This selected thread/fiber may reflect each of the operations (e.g., coalescing operations) that were previously performed for a sub-wave. The selected thread/fiber may also be used for a next hierarchical wave operation (e.g., a hierarchical coalescing operation). Aspects presented herein may also perform the aforementioned wave or sub-wave operations in a parallel manner. By performing the operations in a parallel manner, aspects of the present disclosure may perform the aforementioned wave or sub-wave operations in a more efficient way compared to other types of approaches (e.g., serial approaches). As such, aspects presented herein may reduce the amount of time and/or power at a GPU in order to perform the wave or sub-wave operations.

Aspects presented herein may enable sub-wave operations (e.g., parallel sub-wave operations) using a certain operation that identifies or selects a last thread or fiber at each sub-wave. That is, aspects presented herein may activate a thread/fiber (e.g., a last thread/fiber) in a subgroup or sub-wave in order to enable parallel sub-wave operations. For example, aspects presented herein may utilize a get-last multiple instruction that identifies or selects a last active thread or fiber at each sub-wave. This can be used, for example, to implement atomic operations (e.g., atomic adds) on a reduced number of threads/fibers, instead of utilizing atomic increments on every thread/fiber. For sub-wave math operations, this allows coalescing to be performed in reduced chunks and the operations do not have be performed in a serial manner. Indeed, the operations (e.g., sub-wave operations) may be performed in a parallel manner on each sub-wave. This parallel approach is more efficient than other approaches (e.g., serial approaches), as the operations (e.g., sub-wave operations) may be performed simultaneously as operations on other sub-waves. Accordingly, these parallel sub-wave operations may be performed in a reduced amount of time and energy compared to other operations (e.g., serial operations).

Additionally, aspects presented herein may allocate a wave into a set of sub-waves, and then provide for the selection of a representative thread/fiber (e.g., a last active thread/fiber) for each sub-wave in the set of sub-waves. Aspects presented herein may then allow each of these representative threads/fibers to operate in parallel, which is a more efficient approach than other types of operations (e.g., serial operations). Further, aspects presented herein may utilize an operation or algorithm (e.g., a get-last multi operation or a get-last multiple operation) that selects a representative thread/fiber (e.g., a last active thread/fiber) for each sub-wave. Indeed, the operation (e.g., a get-last multi operation or a get-last multiple operation) that selects a representative thread/fiber (e.g., a last active thread/fiber) may allow the operations to be performed in parallel. Besides making normal full wave operations (e.g., wave math operations) more efficient, such a parallel approach may enable sub-wave operations (e.g., sub-wave wave math operations) to be more efficient as well. In some instances, aspects presented herein may allow trade-offs or switches between certain types of operations. For example, aspects presented herein may allow trade-offs between per-fiber atomic increment operations (atomic_increment operations) with a smaller number of sub-wave atomic addition operations (atomic_add operations). There may be some overhead for coalescing atomic increment operations (atomic_increment operations) into atomic addition operations (atomic_add operations).

In some aspects, sub-wave math operations may allow coalescing to be performed in smaller increments, and then an operation that selects a last active thread/fiber (e.g., a get-last multiple operation) may activate a single thread/fiber to perform the operation (e.g., an atomic_add operation). For example, for certain values of threads/fibers (e.g., fiber 0=1, fiber 1=1, fiber 2=1, and fiber 3=1), there may be individual atomic increments (e.g., 4 individual atomic increments) where all fibers execute. For the next values of threads/fibers (e.g., fiber 0=1, fiber 1=2, fiber 2=1, and fiber 3=2), aspects presented herein use a sub-wave prefix sum followed by an operation that selects a last active thread/fiber (e.g., a get-last multiple operation) to perform an atomic_add operation for certain threads/fibers (e.g., fiber 1 and fiber 3). In the above case, just 2 atomic operations may be performed rather than 4 atomic operations in the previous case. Thus, aspects presented herein may utilize operations that select a last active thread/fiber (e.g., a get-last multiple operation) in order to improve the performance of certain types of operations (e.g., wave operations or atomic operations) if those operations were a factor limiting performance.

In some instances, aspects presented herein may utilize an operation that selects a last active thread/fiber (e.g., a get-last multiple operation) in order to be able to operate on a sub-wave basis. Aspects presented herein may make one fiber within that sub-wave active (the selected last active thread/fiber from the get-last multiple operation), which may reflect all of the performed coalescing within the sub-wave. Further, the selected last active thread/fiber from the get-last multiple operation may be used for the next hierarchical wave operation or coalescing operation. For instance, if a certain number of fibers have been activated based on the get-last multiple operation (e.g., ¼ of the active fibers), and then aspects presented herein may perform a corresponding number of operations (e.g., wave operations or atomic operations), which will result in a reduced number of operations (e.g., wave operations or atomic operations) being performed (e.g., ¼ of the operations). As indicated herein, an atomic operation may enable another operation (e.g., a read-modify-write operation or a read-write operation) to occur without any interruption from any other processor at a GPU. That is, an atomic operation may assure that no matter what order of operations from other GPU processors, the final value is still going to be correct and definitive. Also, the width of the sub-wave (i.e., the amount of sub-waves or subdivisions with a wave or sub-wave) may be an input to the operation, which allows flexibility in terms of that trade off regarding the size of the sub-wave. For example, if a wave size is 64, and a get-last multiple operation of size 4 is performed, then each sub-wave may be equal to a size 4, which corresponds to 16 sub-waves within the larger wave size of 64.

In some instances, aspects presented herein may utilize an operation that selects a last active thread/fiber (e.g., a get-last multiple operation) for certain types of operations (e.g., wave operations or atomic operations at a GPU). This type of get-last operation may be performed in a parallel fashion, as there may be an inefficiency for these types of operations (e.g., when using wave math for reduction) that are performed in a serial fashion. That is, operations that selects a last active thread/fiber (e.g., a get-last multiple operation) may be performed in parallel to obtain a last active thread/fiber at a cluster level (e.g., for each sub-wave in a set of sub-waves). Each sub-wave in a set of sub-waves may correspond to a cluster, and the cluster may include a set of threads for each sub-wave in the set of sub-waves. By utilizing a get-last multiple operation in parallel on each sub-wave in a set of sub-waves, aspects presented herein may replace certain operations (e.g., atomic minimum/maximum operations) with other types of operations (e.g., wave math operations). Further, by utilizing a get-last multiple operation in parallel on each sub-wave in a set of sub-waves, aspects presented herein may allow for an improvement (e.g., a 10% improvement) compared with operations that are run in a serial fashion to determine active threads/fibers. For instance, operations that are run in a serial fashion to determine active threads/fibers may be inefficient, as extra control flow instruction may be needed inside a loop (getone loop) for serialization (e.g., loop needed for uniform atomic coalescence). In one example, such an inefficient operation may be represented by the code below, where the operation to determine active threads/fibers is performed serially inside a loop:
LOOP:
   getlast.w8 DONE//5×8 Cycles
   movs uGPR=Temp
   add.f Temp=uGPR+SRC
   getone LOOP
DONE:
END

Aspects presented herein may utilize operations that identify a last active thread/fiber (e.g., a get-last multiple operation) that is performed in parallel and outside of a loop. Indeed, this type of get-last multiple operation (e.g., getlast_multi.w [2|4|8]) may be performed in a parallel fashion, as there is an inefficiency for these types of operations that are performed in a serial fashion. Aspects presented herein may perform the get-last multiple operation in parallel in order to determine a last active fiber for each cluster, where each sub-wave in a set of sub-waves may correspond to a cluster, and a cluster may include a set of threads/fibers for each sub-wave. The clusters may be any appropriate size (e.g., 2 threads/fibers, 4 threads/fibers, 8 threads/fibers, 16 threads/fibers, 32 threads/fibers, 64 threads/fibers, etc.). In one example, the efficient operation that identifies a last active thread/fiber may be represented by the code below, where the operation to determine the last active thread/fiber is performed in parallel and outside of a loop:
getlast_multi.w8 DONE
LOOP:
   movs uGPR=Temp
   add.f Temp=uGPR+SRC
   getone LOOP
DONE:
END

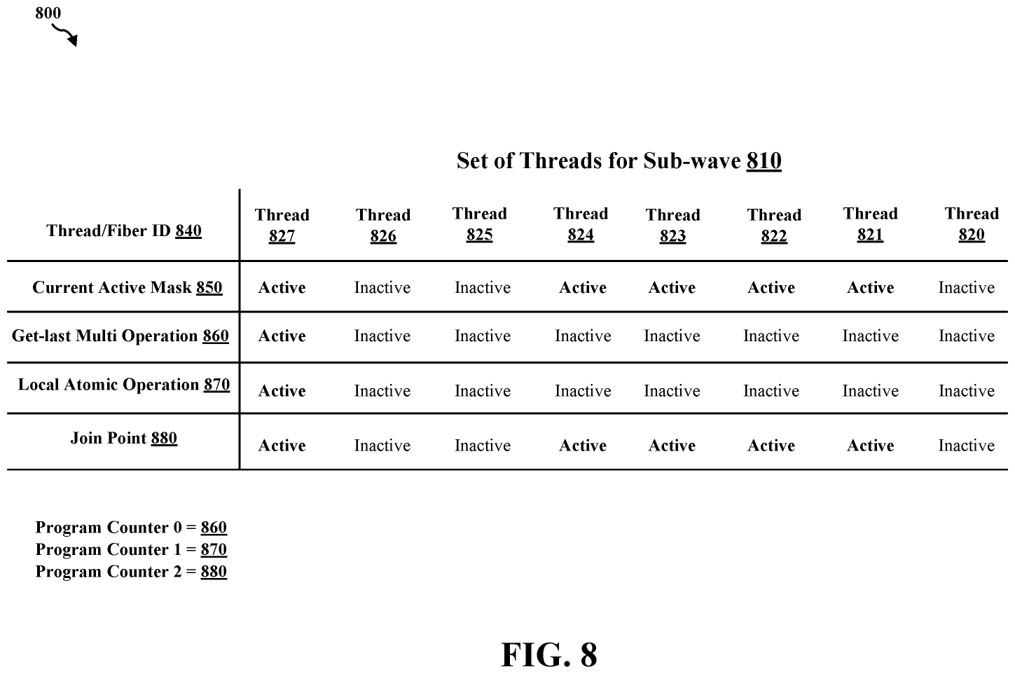

FIG. 8 illustrates diagram 800 including one example of a wave operation. More specifically, diagram 800 depicts one example of an operation that selects a last active thread/fiber (e.g., a get-last multiple operation) that is performed in parallel for each sub-wave in a set of sub-waves. As shown in FIG. 8, diagram 800 includes sub-wave 810 including a set of threads (e.g., thread 820, thread 821, thread 822, thread 823, thread 824, thread 825, thread 826, and thread 827). Diagram 800 also includes a thread/fiber ID 840, a current active mask 850, a get-last multiple operation 860 (e.g., an operation that selects a last active thread/fiber), a local atomic operation 870, and join point 880. Further, diagram 800 depicts that program counter 0 (e.g., a first instruction) corresponds to the get-last multiple operation 860, program counter 1 (e.g., a second instruction) corresponds to local atomic operation 870, and program counter 2 (e.g., a third instruction) corresponds to join point 880. As shown in FIG. 8, a thread/fiber ID 840 corresponds to each of the set of threads (e.g., thread 820, thread 821, thread 822, thread 823, thread 824, thread 825, thread 826, and thread 827). During the current active mask 850 step, a number of threads are active and inactive. For example, at current active mask 850 step, thread 820 is inactive, thread 821 is active, thread 822 is active, thread 823 is active, thread 824 is active, thread 825 is inactive, thread 826 is inactive, and thread 827 is active. During the get-last multiple operation 860, a last active thread/fiber is selected within the set of threads for sub-wave 810. For example, during the get-last multiple operation 860, thread 827 is selected as the last active thread. After this, all remaining active threads other than thread 827 are inactivated. For example, thread 821, thread 822, thread 823, and thread 824 are inactivated, such that thread 820, thread 821, thread 822, thread 823, thread 824, thread 825, and thread 826 are now inactive. Next, local atomic operation 870 is performed via the last active thread. For example, local atomic operation 870 is performed via thread 827. After this, the remaining threads that were previously inactivated are reactivated, which corresponds to join point 880. For example, thread 821, thread 822, thread 823, and thread 824 are reactivated, such that thread 821, thread 822, thread 823, thread 824, and thread 827 are now active.

As shown in FIG. 8, apparatuses described herein (e.g., a shader processor or shader instruction set at a GPU) may allocate a wave into a set of sub-waves, where each sub-wave in the set of sub-waves comprises a set of threads. For example, sub-wave 810 comprises a set of threads (e.g., thread 820, thread 821, thread 822, thread 823, thread 824, thread 825, thread 826, and thread 827). Apparatuses described herein (e.g., a shader processor or shader instruction set at a GPU) may also perform a set of wave operations for each sub-wave in the set of sub-waves. For example, current active mask 850 may be a set of wave operations that is performed for sub-wave 810. Apparatuses described herein (e.g., a shader processor or shader instruction set at a GPU) may also identify, based on the set of wave operations, a last active thread from amongst the set of threads for each sub-wave in the set of sub-waves. For example, during get-last multiple operation 860, thread 827 is identified or selected as the last active thread for sub-wave 810. Apparatuses described herein (e.g., a shader processor or shader instruction set at a GPU) may also inactivate, based on the identification of the last active thread, one or more remaining threads in the set of threads for each sub-wave in the set of sub-waves, where the one or more remaining threads do not include the last active thread. For example, after get-last multiple operation 860, thread 821, thread 822, thread 823, and thread 824 are inactivated, such that thread 820, thread 821, thread 822, thread 823, thread 824, thread 825, and thread 826 are now inactive. Apparatuses described herein (e.g., a shader processor or shader instruction set at a GPU) may also perform a set of operations (e.g., wave operations or atomic operations) via the last active thread for each sub-wave in the set of sub-waves. For example, local atomic operation 870 is performed via thread 827, which is the last active thread for sub-wave 810. Apparatuses described herein (e.g., a shader processor or shader instruction set at a GPU) may also reactivate the one or more remaining threads in the set of threads that were previously inactivated. For example, corresponding to join point 880, thread 821, thread 822, thread 823, and thread 824 are reactivated, such that thread 821, thread 822, thread 823, thread 824, and thread 827 are now active.

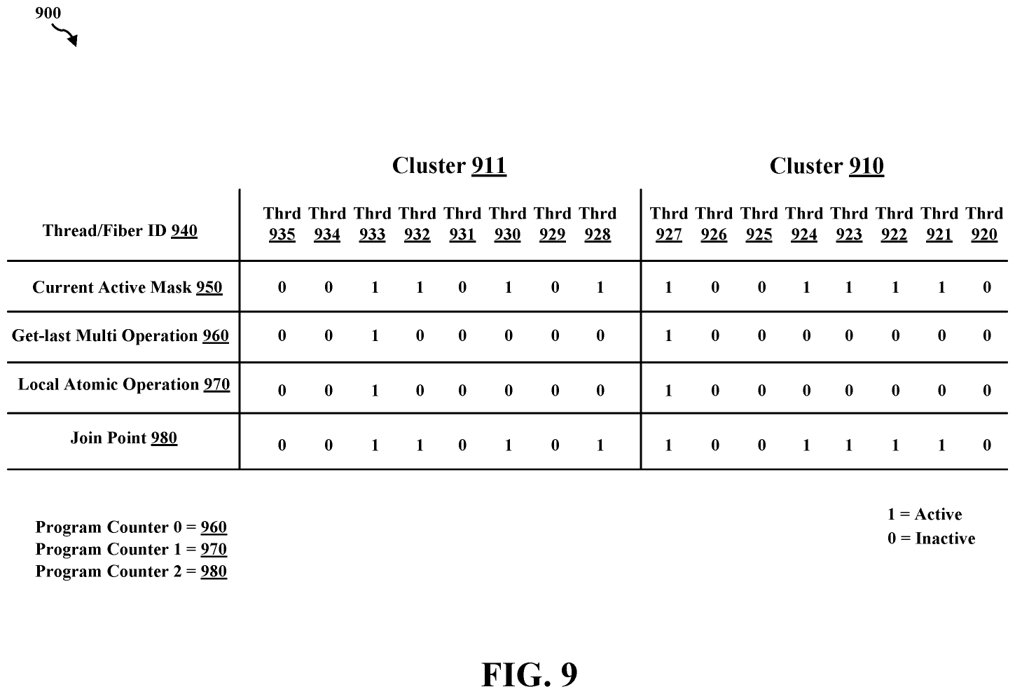

FIG. 9 illustrates diagram 900 including one example of a wave operation. More specifically, diagram 900 depicts one example of an operation that selects a last active thread/fiber (e.g., a get-last multiple operation) that is performed in parallel for each cluster or sub-wave. As shown in FIG. 9, diagram 900 includes cluster 910 including a set of threads (e.g., thread 920, thread 921, thread 922, thread 923, thread 924, thread 925, thread 926, and thread 927) and cluster 911 including a set of threads (e.g., thread 928, thread 929, thread 930, thread 931, thread 932, thread 933, thread 934, and thread 935). Diagram 900 also includes a thread/fiber ID 940, a current active mask 950, a get-last multiple operation 960 (e.g., an operation that selects a last active thread/fiber), a local atomic operation 970, and join point 980. Further, diagram 900 depicts that program counter 0 corresponds to the get-last multiple operation 960, program counter 1 corresponds to local atomic operation 970, and program counter 2 corresponds to join point 980. As shown in FIG. 9, a thread/fiber ID 940 corresponds to each of the set of threads (e.g., thread 920, thread 921, thread 922, thread 923, thread 924, thread 925, thread 926, and thread 927 in cluster 910, as well as (e.g., thread 928, thread 929, thread 930, thread 931, thread 932, thread 933, thread 934, and thread 935 in cluster 911). During the current active mask 950 step, a number of threads are active and inactive. For example, at current active mask 950 step for cluster 910, thread 920 is inactive, thread 921 is active, thread 922 is active, thread 923 is active, thread 924 is active, thread 925 is inactive, thread 926 is inactive, and thread 927 is active. At current active mask 950 step for cluster 911, thread 928 is active, thread 929 is active, thread 930 is active, thread 931 is inactive, thread 932 is active, thread 933 is active, thread 934 is inactive, and thread 935 is inactive. During the get-last multiple operation 960, a last active thread/fiber is selected within the set of threads for cluster 910 and cluster 911. For example, during the get-last multiple operation 960, thread 927 is selected as the last active thread for cluster 910 and thread 933 is selected as the last active thread for cluster 911. After this, all remaining active threads other than thread 927 are inactivated for cluster 910, and all remaining active threads other than thread 933 are inactivated for cluster 911. For example, thread 921, thread 922, thread 923, and thread 924 are inactivated for cluster 910, such that thread 920, thread 921, thread 922, thread 923, thread 924, thread 925, and thread 926 are now inactive for cluster 910. Also, thread 928, thread 930, and thread 932 are inactivated for cluster 911, such that thread 928, thread 929, thread 930, thread 931, thread 932, thread 934, and thread 935 are now inactive for cluster 911. Next, local atomic operation 970 is performed via the last active thread. For example, local atomic operation 970 is performed via thread 927 for cluster 910, and local atomic operation 970 is performed via thread 933 for cluster 911. After this, the remaining threads that were previously inactivated are reactivated, which corresponds to join point 980. For example, thread 921, thread 922, thread 923, and thread 924 are reactivated for cluster 910, such that thread 921, thread 922, thread 923, thread 924, and thread 927 are now active for cluster 910. Also, thread 928, thread 930, and thread 932 are reactivated for cluster 911, such that thread 928, thread 930, thread 932, and thread 933 are now active for cluster 911.

As shown in FIG. 9, apparatuses described herein (e.g., a shader processor or shader instruction set at a GPU) may allocate a wave into a set of sub-waves, where each sub-wave in the set of sub-waves comprises a set of threads. For example, cluster 910 comprises a set of threads (e.g., thread 920, thread 921, thread 922, thread 923, thread 924, thread 925, thread 926, and thread 927). Also, cluster 911 comprises a set of threads (e.g., thread 928, thread 929, thread 930, thread 931, thread 932, thread 933, thread 934, and thread 935). Apparatuses described herein (e.g., a shader processor or shader instruction set at a GPU) may also perform a set of wave operations for each sub-wave in the set of sub-waves. For example, current active mask 950 may be a set of wave operations that is performed for cluster 910 and cluster 911. Apparatuses described herein (e.g., a shader processor or shader instruction set at a GPU) may also identify, based on the set of wave operations, a last active thread from amongst the set of threads for each sub-wave in the set of sub-waves. For example, during get-last multiple operation 960, thread 927 is identified or selected as the last active thread for cluster 910. Also, during get-last multiple operation 960, thread 933 is identified or selected as the last active thread for cluster 911. Apparatuses described herein (e.g., a shader processor or shader instruction set at a GPU) may also inactivate, based on the identification of the last active thread, one or more remaining threads in the set of threads for each sub-wave in the set of sub-waves, where the one or more remaining threads do not include the last active thread. For example, after get-last multiple operation 960, thread 921, thread 922, thread 923, and thread 924 are inactivated for cluster 910, such that thread 920, thread 921, thread 922, thread 923, thread 924, thread 925, and thread 926 are now inactive for cluster 910. Also, after get-last multiple operation 960, thread 928, thread 930, and thread 932 are inactivated for cluster 911, such that thread 928, thread 929, thread 930, thread 931, thread 932, thread 934, and thread 935 are now inactive for cluster 911. Apparatuses described herein (e.g., a shader processor or shader instruction set at a GPU) may also perform a set of operations (e.g., wave operations or atomic operations) via the last active thread for each sub-wave in the set of sub-waves. For example, local atomic operation 970 is performed via thread 927 for cluster 910, which is the last active thread for cluster 910. Also, local atomic operation 970 is performed via thread 933 for cluster 911, which is the last active thread for cluster 911. Apparatuses described herein (e.g., a shader processor or shader instruction set at a GPU) may also reactivate the one or more remaining threads in the set of threads that were previously inactivated. For example, corresponding to join point 980, thread 921, thread 922, thread 923, and thread 924 are reactivated for cluster 910, such that thread 921, thread 922, thread 923, thread 924, and thread 927 are now active for cluster 910. Also, corresponding to join point 980, thread 928, thread 930, and thread 932 are reactivated for cluster 911, such that thread 928, thread 930, thread 932, and thread 933 are now active for cluster 911.

Aspects of the present disclosure may include a number of benefits or advantages. For instance, aspects of the present disclosure may perform a number of wave operations or sub-wave operations, then identify or select a representative fiber from each wave or sub-wave, and then allow the representative fiber from each sub-wave to work on a combined/final value from each sub-wave. That is, aspects presented herein may identify or select a thread/fiber within a particular sub-wave, and then activate the thread/fiber. The selected thread/fiber may also be used for a next hierarchical wave operation (e.g., a hierarchical coalescing operation). Aspects presented herein may also perform the aforementioned wave or sub-wave operations in a parallel manner. By performing the operations in a parallel manner, aspects of the present disclosure may perform the aforementioned wave or sub-wave operations in a more efficient way compared to other types of approaches (e.g., serial approaches). As such, aspects presented herein may reduce the amount of time and/or power at a GPU in order to perform the wave or sub-wave operations. Moreover, aspects presented herein may obtain a better clustered reduction support aligned with other application program interfaces (APIs). Also, aspects presented herein may obtain a performance improvement for certain types of operations (e.g., wave math based reduction operations). Aspects presented herein may also obtain a certain optimization (e.g., a uniform address atomics optimization) that can be performed at a cluster level.

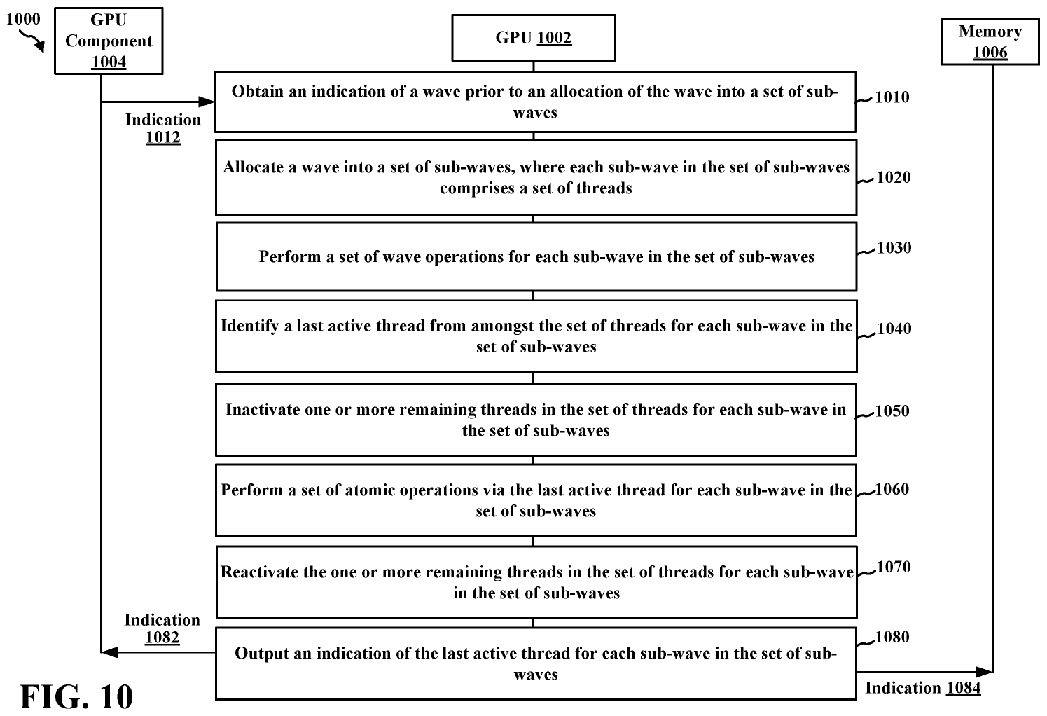

FIG. 10 is a communication flow diagram 1000 of graphics processing in accordance with one or more techniques of this disclosure. As shown in FIG. 10, diagram 1000 includes example communications between GPU 1002 (e.g., a GPU, a shader processor at a GPU, a GPU component, another graphics processor, a CPU, a CPU component, or another central processor), GPU component 1004 (e.g., a GPU, a shader processor at a GPU, a GPU component, another graphics processor, a CPU, a CPU component, or another central processor), and memory 1006 (e.g., a memory, a cache, a system memory, a graphics memory, a memory or cache at a CPU, or a memory or cache at a GPU), in accordance with one or more techniques of this disclosure.

At 1010, GPU 1002 may obtain an indication of a wave prior to an allocation of the wave into a set of sub-waves (e.g., GPU 1002 may obtain indication 1012 from GPU component 1004), where the allocation of the wave into the set of sub-waves is based on the obtained wave.

At 1020, GPU 1002 may allocate a wave into a set of sub-waves, where each sub-wave in the set of sub-waves comprises a set of threads. In some aspects, each sub-wave in the set of sub-waves may correspond to a cluster, and the cluster may include the set of threads for each sub-wave in the set of sub-waves. Further, each of the set of threads in the cluster may be associated with at least one of: a fiber identifier (ID), a current active mask, a get-last multiple operation, a local atomic operation, or a join point. In some aspects, the set of threads in the cluster may include two (2) threads, four (4) threads, eight (8) threads, or sixteen (16) threads.

At 1030, GPU 1002 may perform a set of wave operations for each sub-wave in the set of sub-waves.

At 1040, GPU 1002 may identify, based on the set of wave operations, a last active thread from amongst the set of threads for each sub-wave in the set of sub-waves. In some aspects, identifying the last active thread for each sub-wave in the set of sub-waves may comprise identifying, in parallel, the last active thread for each sub-wave in the set of sub-waves. Further, identifying, in parallel, the last active thread for each sub-wave in the set of sub-waves may comprise identifying, in parallel, the last active thread for each sub-wave in the set of sub-waves outside of a loop operation associated with the set of wave operations for each sub-wave in the set of sub-waves. Also, identifying the last active thread from amongst the set of threads for each sub-wave in the set of sub-waves may comprise selecting the last active thread from amongst a plurality of active threads for each sub-wave in the set of sub-waves. Selecting the last active thread from amongst the plurality of active threads for each sub-wave in the set of sub-waves may comprise selecting, via a get-last multiple operation, the last active thread from amongst the plurality of active threads for each sub-wave in the set of sub-waves. In some aspects, the last active thread may be a last active fiber, and the plurality of active threads may be a plurality of active fibers for each sub-wave in the set of sub-waves.

At 1050, GPU 1002 may inactivate, based on the identification of the last active thread, one or more remaining threads in the set of threads for each sub-wave in the set of sub-waves, where the one or more remaining threads do not include the last active thread. In some aspects, inactivating the one or more remaining threads in the set of threads for each sub-wave in the set of sub-waves may comprise inactivating the one or more remaining threads in the set of threads for each sub-wave in the set of sub-waves until a target program counter is reached.

At 1060, GPU 1002 may perform, based on the inactivation of the one or more remaining threads, a set of atomic operations via the last active thread for each sub-wave in the set of sub-waves. In some aspects, performing the set of atomic operations via the last active thread for each sub-wave in the set of sub-waves may comprise enabling, via the last active thread for each sub-wave in the set of sub-waves, at least one of a set of read operations, a set of modify operations, or a set of write operations to occur without any interruption.

At 1070, GPU 1002 may reactivate, based on the performance of the set of atomic operations, the one or more remaining threads in the set of threads for each sub-wave in the set of sub-waves.

At 1080, GPU 1002 may output an indication of the last active thread for each sub-wave in the set of sub-waves. In some aspects, outputting the indication of the last active thread for each sub-wave in the set of sub-waves may comprise transmitting, to at least one component at a graphics processing unit (GPU) or a central processing unit (CPU), the indication of the last active thread for each sub-wave in the set of sub-waves (e.g., GPU 1002 may transmit indication 1082 to GPU component 1004). Also, outputting the indication of the last active thread for each sub-wave in the set of sub-waves may comprise storing, in a graphics processing unit (GPU), the indication of the last active thread for each sub-wave in the set of sub-waves (e.g., GPU 1002 may store indication 1084 in memory 1006).

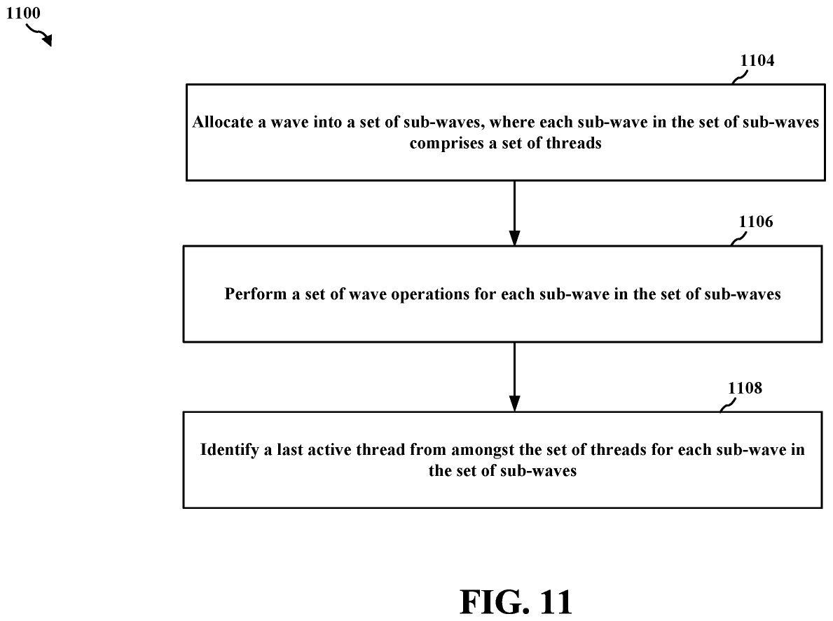

FIG. 11 is a flowchart 1100 of an example method of graphics processing in accordance with one or more techniques of this disclosure. The method may be performed by a GPU (e.g., a GPU, a shader processor at a GPU, a GPU component, another graphics processor, a CPU, a CPU component, or another central processor), a CPU (e.g., a CPU, a CPU component, another central processor, a GPU, a shader processor at a GPU, a GPU component, or another graphics processor), a display driver integrated circuit (DDIC), an apparatus for graphics processing, a wireless communication device, and/or any apparatus that may perform graphics processing as used in connection with the examples of FIGS. 1-10.

At 1104, the GPU may allocate a wave into a set of sub-waves, where each sub-wave in the set of sub-waves comprises a set of threads, as described in connection with the examples in FIGS. 1-10. For example, as described in 1020 of FIG. 10, GPU 1002 may allocate a wave into a set of sub-waves, where each sub-wave in the set of sub-waves comprises a set of threads. Further, step 1104 may be performed by processing unit 120 in FIG. 1. In some aspects, each sub-wave in the set of sub-waves may correspond to a cluster, and the cluster may include the set of threads for each sub-wave in the set of sub-waves. Further, each of the set of threads in the cluster may be associated with at least one of: a fiber identifier (ID), a current active mask, a get-last multiple operation, a local atomic operation, or a join point. In some aspects, the set of threads in the cluster may include two (2) threads, four (4) threads, eight (8) threads, or sixteen (16) threads.

At 1106, the GPU may perform a set of wave operations for each sub-wave in the set of sub-waves, as described in connection with the examples in FIGS. 1-10. For example, as described in 1030 of FIG. 10, GPU 1002 may perform a set of wave operations for each sub-wave in the set of sub-waves. Further, step 1106 may be performed by processing unit 120 in FIG. 1.

At 1108, the GPU may identify, based on the set of wave operations, a last active thread from amongst the set of threads for each sub-wave in the set of sub-waves, as described in connection with the examples in FIGS. 1-10. For example, as described in 1040 of FIG. 10, GPU 1002 may identify, based on the set of wave operations, a last active thread from amongst the set of threads for each sub-wave in the set of sub-waves. Further, step 1108 may be performed by processing unit 120 in FIG. 1. In some aspects, identifying the last active thread for each sub-wave in the set of sub-waves may comprise identifying, in parallel, the last active thread for each sub-wave in the set of sub-waves. Further, identifying, in parallel, the last active thread for each sub-wave in the set of sub-waves may comprise identifying, in parallel, the last active thread for each sub-wave in the set of sub-waves outside of a loop operation associated with the set of wave operations for each sub-wave in the set of sub-waves. Also, identifying the last active thread from amongst the set of threads for each sub-wave in the set of sub-waves may comprise selecting the last active thread from amongst a plurality of active threads for each sub-wave in the set of sub-waves. Selecting the last active thread from amongst the plurality of active threads for each sub-wave in the set of sub-waves may comprise selecting, via a get-last multiple operation, the last active thread from amongst the plurality of active threads for each sub-wave in the set of sub-waves. In some aspects, the last active thread may be a last active fiber, and the plurality of active threads may be a plurality of active fibers for each sub-wave in the set of sub-waves.

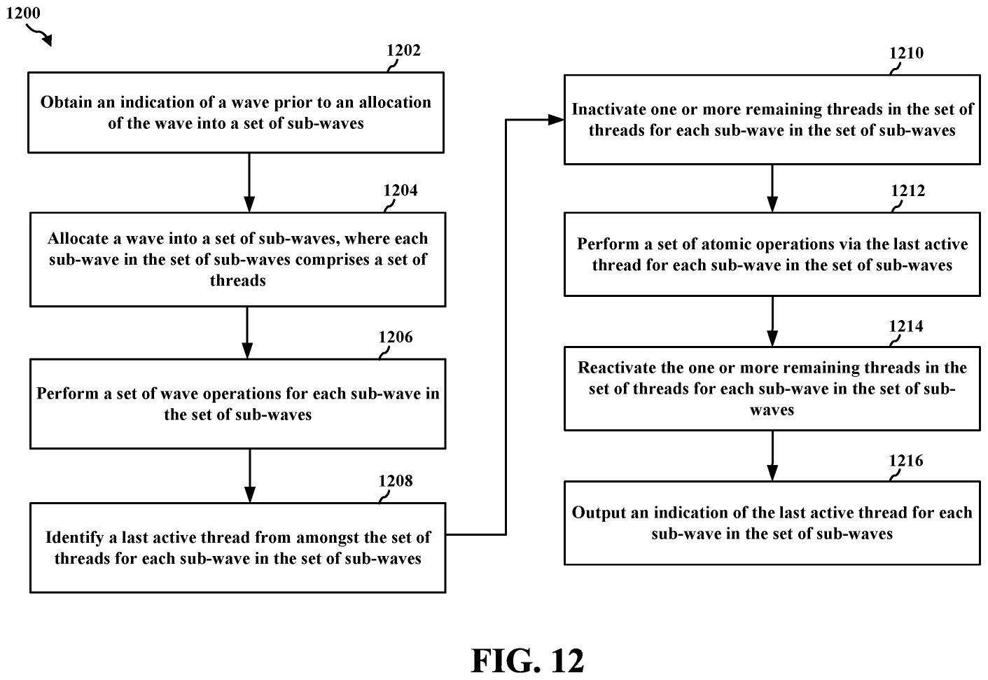

FIG. 12 is a flowchart 1200 of an example method of graphics processing in accordance with one or more techniques of this disclosure. The method may be performed by a GPU (e.g., a GPU, a shader processor at a GPU, a GPU component, another graphics processor, a CPU, a CPU component, or another central processor), a CPU (e.g., a CPU, a CPU component, another central processor, a GPU, a shader processor at a GPU, a GPU component, or another graphics processor), a display driver integrated circuit (DDIC), an apparatus for graphics processing, a wireless communication device, and/or any apparatus that may perform graphics processing as used in connection with the examples of FIGS. 1-10.

At 1202, the GPU may obtain an indication of a wave prior to an allocation of the wave into a set of sub-waves, where the allocation of the wave into the set of sub-waves is based on the obtained wave, as described in connection with the examples in FIGS. 1-10. For example, as described in 1010 of FIG. 10, GPU 1002 may obtain an indication of a wave prior to an allocation of the wave into a set of sub-waves, where the allocation of the wave into the set of sub-waves is based on the obtained wave. Further, step 1202 may be performed by processing unit 120 in FIG. 1.

At 1204, the GPU may allocate a wave into a set of sub-waves, where each sub-wave in the set of sub-waves comprises a set of threads, as described in connection with the examples in FIGS. 1-10. For example, as described in 1020 of FIG. 10, GPU 1002 may allocate a wave into a set of sub-waves, where each sub-wave in the set of sub-waves comprises a set of threads. Further, step 1204 may be performed by processing unit 120 in FIG. 1. In some aspects, each sub-wave in the set of sub-waves may correspond to a cluster, and the cluster may include the set of threads for each sub-wave in the set of sub-waves. Further, each of the set of threads in the cluster may be associated with at least one of: a fiber identifier (ID), a current active mask, a get-last multiple operation, a local atomic operation, or a join point. In some aspects, the set of threads in the cluster may include two (2) threads, four (4) threads, eight (8) threads, or sixteen (16) threads.

At 1206, the GPU may perform a set of wave operations for each sub-wave in the set of sub-waves, as described in connection with the examples in FIGS. 1-10. For example, as described in 1030 of FIG. 10, GPU 1002 may perform a set of wave operations for each sub-wave in the set of sub-waves. Further, step 1206 may be performed by processing unit 120 in FIG. 1.

At 1208, the GPU may identify, based on the set of wave operations, a last active thread from amongst the set of threads for each sub-wave in the set of sub-waves, as described in connection with the examples in FIGS. 1-10. For example, as described in 1040 of FIG. 10, GPU 1002 may identify, based on the set of wave operations, a last active thread from amongst the set of threads for each sub-wave in the set of sub-waves. Further, step 1208 may be performed by processing unit 120 in FIG. 1. In some aspects, identifying the last active thread for each sub-wave in the set of sub-waves may comprise identifying, in parallel, the last active thread for each sub-wave in the set of sub-waves. Further, identifying, in parallel, the last active thread for each sub-wave in the set of sub-waves may comprise identifying, in parallel, the last active thread for each sub-wave in the set of sub-waves outside of a loop operation associated with the set of wave operations for each sub-wave in the set of sub-waves. Also, identifying the last active thread from amongst the set of threads for each sub-wave in the set of sub-waves may comprise selecting the last active thread from amongst a plurality of active threads for each sub-wave in the set of sub-waves. Selecting the last active thread from amongst the plurality of active threads for each sub-wave in the set of sub-waves may comprise selecting, via a get-last multiple operation, the last active thread from amongst the plurality of active threads for each sub-wave in the set of sub-waves. In some aspects, the last active thread may be a last active fiber, and the plurality of active threads may be a plurality of active fibers for each sub-wave in the set of sub-waves.

At 1210, the GPU may inactivate, based on the identification of the last active thread, one or more remaining threads in the set of threads for each sub-wave in the set of sub-waves, where the one or more remaining threads do not include the last active thread, as described in connection with the examples in FIGS. 1-10. For example, as described in 1050 of FIG. 10, GPU 1002 may inactivate, based on the identification of the last active thread, one or more remaining threads in the set of threads for each sub-wave in the set of sub-waves, where the one or more remaining threads do not include the last active thread. Further, step 1210 may be performed by processing unit 120 in FIG. 1. In some aspects, inactivating the one or more remaining threads in the set of threads for each sub-wave in the set of sub-waves may comprise inactivating the one or more remaining threads in the set of threads for each sub-wave in the set of sub-waves until a target program counter is reached.

At 1212, the GPU may perform, based on the inactivation of the one or more remaining threads, a set of atomic operations via the last active thread for each sub-wave in the set of sub-waves, as described in connection with the examples in FIGS. 1-10. For example, as described in 1060 of FIG. 10, GPU 1002 may perform, based on the inactivation of the one or more remaining threads, a set of atomic operations via the last active thread for each sub-wave in the set of sub-waves. Further, step 1212 may be performed by processing unit 120 in FIG. 1. In some aspects, performing the set of atomic operations via the last active thread for each sub-wave in the set of sub-waves may comprise enabling, via the last active thread for each sub-wave in the set of sub-waves, at least one of a set of read operations, a set of modify operations, or a set of write operations to occur without any interruption.

At 1214, the GPU may reactivate, based on the performance of the set of atomic operations, the one or more remaining threads in the set of threads for each sub-wave in the set of sub-waves, as described in connection with the examples in FIGS. 1-10. For example, as described in 1070 of FIG. 10, GPU 1002 may reactivate, based on the performance of the set of atomic operations, the one or more remaining threads in the set of threads for each sub-wave in the set of sub-waves. Further, step 1214 may be performed by processing unit 120 in FIG. 1.

At 1216, the GPU may output an indication of the last active thread for each sub-wave in the set of sub-waves, as described in connection with the examples in FIGS. 1-10. For example, as described in 1080 of FIG. 10, GPU 1002 may output an indication of the last active thread for each sub-wave in the set of sub-waves. Further, step 1216 may be performed by processing unit 120 in FIG. 1. In some aspects, outputting the indication of the last active thread for each sub-wave in the set of sub-waves may comprise transmitting, to at least one component at a graphics processing unit (GPU) or a central processing unit (CPU), the indication of the last active thread for each sub-wave in the set of sub-waves. Also, outputting the indication of the last active thread for each sub-wave in the set of sub-waves may comprise storing, in a graphics processing unit (GPU), the indication of the last active thread for each sub-wave in the set of sub-waves.

In configurations, a method or an apparatus for graphics processing is provided. The apparatus may be a GPU (or other graphics processor), a CPU (or other central processor), a DDIC, an apparatus for graphics processing, and/or some other processor that may perform graphics processing. In aspects, the apparatus may be the processing unit 120 within the device 104, or may be some other hardware within the device 104 or another device. The apparatus, e.g., processing unit 120, may include means for allocating a wave into a set of sub-waves, where each sub-wave in the set of sub-waves comprises a set of threads. The apparatus, e.g., processing unit 120, may include means for performing a set of wave operations for each sub-wave in the set of sub-waves. The apparatus, e.g., processing unit 120, may include means for identifying, based on the set of wave operations, a last active thread from amongst the set of threads for each sub-wave in the set of sub-waves. The apparatus, e.g., processing unit 120, may include means for inactivating, based on the identification of the last active thread, one or more remaining threads in the set of threads for each sub-wave in the set of sub-waves, where the one or more remaining threads do not include the last active thread. The apparatus, e.g., processing unit 120, may include means for performing, based on the inactivation of the one or more remaining threads, a set of atomic operations via the last active thread for each sub-wave in the set of sub-waves. The apparatus, e.g., processing unit 120, may include means for reactivating, based on the performance of the set of atomic operations, the one or more remaining threads in the set of threads for each sub-wave in the set of sub-waves. The apparatus, e.g., processing unit 120, may include means for obtaining an indication of the wave prior to the allocation of the wave into the set of sub-waves, where the allocation of the wave into the set of sub-waves is based on the obtained wave. The apparatus, e.g., processing unit 120, may include means for outputting an indication of the last active thread for each sub-wave in the set of sub-waves.

The subject matter described herein may be implemented to realize one or more benefits or advantages. For instance, the described graphics processing techniques may be used by a GPU, a shader processor, a CPU, a central processor, or some other processor that may perform graphics processing to implement the parallel sub-wave operation techniques described herein. This may also be accomplished at a low cost compared to other graphics processing techniques. Moreover, the graphics processing techniques herein may improve or speed up data processing or execution. Further, the graphics processing techniques herein may improve resource or data utilization and/or resource efficiency. Additionally, aspects of the present disclosure may utilize parallel sub-wave operation techniques in order to improve memory bandwidth efficiency and/or increase processing speed at a GPU, a shader processor, a CPU, or a DPU.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

In accordance with this disclosure, the term “or” may be interpreted as “and/or” where context does not dictate otherwise. Additionally, while phrases such as “one or more” or “at least one” or the like may have been used for some features disclosed herein but not others, the features for which such language was not used may be interpreted to have such a meaning implied where context does not dictate otherwise.

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium. Computer-readable media may include computer data storage media or communication media including any medium that facilitates transfer of a computer program from one place to another. In this manner, computer-readable media generally may correspond to (1) tangible computer-readable storage media, which is non-transitory or (2) a communication medium such as a signal or carrier wave. Data storage media may be any available media that may be accessed by one or more computers or one or more processors to retrieve instructions, code and/or data structures for implementation of the techniques described in this disclosure. By way of example, and not limitation, such computer-readable media may comprise RAM, ROM, EEPROM, CD-ROM or other optical disk storage, magnetic disk storage or other magnetic storage devices. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. A computer program product may include a computer-readable medium.

The code may be executed by one or more processors, such as one or more digital signal processors (DSPs), general purpose microprocessors, application specific integrated circuits (ASICs), arithmetic logic units (ALUs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware.

Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.

Aspect 1 is an apparatus for graphics processing, including a memory and a processor coupled to the memory and, based at least in part on information stored in the memory, the processor is configured to: allocate a wave into a set of sub-waves, wherein each sub-wave in the set of sub-waves comprises a set of threads; perform a set of wave operations for each sub-wave in the set of sub-waves; and identify, based on the set of wave operations, a last active thread from amongst the set of threads for each sub-wave in the set of sub-waves.

Aspect 2 is the apparatus of aspect 1, wherein the processor is further configured to: inactivate, based on the identification of the last active thread, one or more remaining threads in the set of threads for each sub-wave in the set of sub-waves, wherein the one or more remaining threads do not include the last active thread.

Aspect 3 is the apparatus of aspect 2, wherein to inactivate the one or more remaining threads in the set of threads for each sub-wave in the set of sub-waves, the processor is configured to: inactivate the one or more remaining threads in the set of threads for each sub-wave in the set of sub-waves until a target program counter is reached.

Aspect 4 is the apparatus of any of aspects 2 to 3, wherein the processor is further configured to: perform, based on the inactivation of the one or more remaining threads, a set of atomic operations via the last active thread for each sub-wave in the set of sub-waves.

Aspect 5 is the apparatus of aspect 4, wherein the processor is further configured to: reactivate, based on the performance of the set of atomic operations, the one or more remaining threads in the set of threads for each sub-wave in the set of sub-waves.

Aspect 6 is the apparatus of any of aspects 4 to 5, wherein to perform the set of atomic operations via the last active thread for each sub-wave in the set of sub-waves, the processor is configured to: enable, via the last active thread for each sub-wave in the set of sub-waves, at least one of a set of read operations, a set of modify operations, or a set of write operations to occur without any interruption.

Aspect 7 is the apparatus of any of aspects 1 to 6, wherein to identify the last active thread for each sub-wave in the set of sub-waves, the processor is configured to: identify, in parallel, the last active thread for each sub-wave in the set of sub-waves.

Aspect 8 is the apparatus of aspect 7, wherein to identify, in parallel, the last active thread for each sub-wave in the set of sub-waves, the processor is configured to: identify, in parallel, the last active thread for each sub-wave in the set of sub-waves outside of a loop operation associated with the set of wave operations for each sub-wave in the set of sub-waves.

Aspect 9 is the apparatus of any of aspects 1 to 8, wherein to identify the last active thread from amongst the set of threads for each sub-wave in the set of sub-waves, the processor is configured to: select the last active thread from amongst a plurality of active threads for each sub-wave in the set of sub-waves.

Aspect 10 is the apparatus of aspect 9, wherein to select the last active thread from amongst the plurality of active threads for each sub-wave in the set of sub-waves, the processor is configured to: select, via a get-last multiple operation, the last active thread from amongst the plurality of active threads for each sub-wave in the set of sub-waves.

Aspect 11 is the apparatus of any of aspects 9 to 10, wherein the last active thread is a last active fiber, and wherein the plurality of active threads is a plurality of active fibers for each sub-wave in the set of sub-waves.

Aspect 12 is the apparatus of any of aspects 1 to 11, wherein each sub-wave in the set of sub-waves corresponds to a cluster, and wherein the cluster includes the set of threads for each sub-wave in the set of sub-waves.

Aspect 13 is the apparatus of aspect 12, wherein each of the set of threads in the cluster is associated with at least one of: a fiber identifier (ID), a current active mask, a get-last multiple operation, a local atomic operation, or a join point.

Aspect 14 is the apparatus of any of aspects 12 to 13, wherein the set of threads in the cluster includes: two (2) threads, four (4) threads, eight (8) threads, sixteen (16) threads, thirty-two (32) threads, or sixty-four (64) threads.

Aspect 15 is the apparatus of any of aspects 1 to 14, wherein the processor is further configured to: obtain an indication of the wave prior to the allocation of the wave into the set of sub-waves, wherein the allocation of the wave into the set of sub-waves is based on the obtained wave.

Aspect 16 is the apparatus of any of aspects 1 to 15, wherein the processor is further configured to: output an indication of the last active thread for each sub-wave in the set of sub-waves.

Aspect 17 is the apparatus of aspect 16, wherein to output the indication of the last active thread for each sub-wave in the set of sub-waves, the processor is configured to: transmit, to at least one component at a graphics processing unit (GPU) or a central processing unit (CPU), the indication of the last active thread for each sub-wave in the set of sub-waves.

Aspect 18 is the apparatus of aspect 16, wherein to output the indication of the last active thread for each sub-wave in the set of sub-waves, the processor is configured to: store, in a graphics processing unit (GPU), the indication of the last active thread for each sub-wave in the set of sub-waves.

Aspect 19 is the apparatus of aspect 16, wherein the apparatus is a wireless communication device, further including (i.e., comprising) at least one of an antenna or a transceiver coupled to the processor, wherein to output the indication of the last active thread for each sub-wave in the set of sub-waves, the processor is configured to: output, via at least one of the antenna or the transceiver, the indication of the last active thread for each sub-wave in the set of sub-waves.

Aspect 20 is a method of graphics processing for implementing any of aspects 1 to 19.

Aspect 21 is an apparatus for graphics processing including means for implementing any of aspects 1 to 19.

Aspect 22 is a computer-readable medium (e.g., a non-transitory computer-readable medium) storing computer executable code (e.g., code for graphics processing), the code when executed by a processor causes the processor to implement any of aspects 1 to 19.

What is claimed is:

1. An apparatus for graphics processing, comprising:
a memory; and
a processor coupled to the memory and, based at least in part on information stored in the memory, the processor is configured to:
allocate a wave into a set of sub-waves, wherein each sub-wave in the set of sub-waves comprises a set of threads;
perform a set of wave operations for each sub-wave in the set of sub-waves; and
identify, based on the set of wave operations, a last active thread from amongst the set of threads for each sub-wave in the set of sub-waves.

2. The apparatus of claim 1, wherein the processor is further configured to:
inactivate, based on the identification of the last active thread, one or more remaining threads in the set of threads for each sub-wave in the set of sub-waves, wherein the one or more remaining threads do not include the last active thread.

3. The apparatus of claim 2, wherein to inactivate the one or more remaining threads in the set of threads for each sub-wave in the set of sub-waves, the processor is configured to:
inactivate the one or more remaining threads in the set of threads for each sub-wave in the set of sub-waves until a target program counter is reached.

4. The apparatus of claim 2, wherein the processor is further configured to:
perform, based on the inactivation of the one or more remaining threads, a set of atomic operations via the last active thread for each sub-wave in the set of sub-waves.

5. The apparatus of claim 4, wherein the processor is further configured to:
reactivate, based on the performance of the set of atomic operations, the one or more remaining threads in the set of threads for each sub-wave in the set of sub-waves.

6. The apparatus of claim 4, wherein to perform the set of atomic operations via the last active thread for each sub-wave in the set of sub-waves, the processor is configured to:
enable, via the last active thread for each sub-wave in the set of sub-waves, at least one of a set of read operations, a set of modify operations, or a set of write operations to occur without any interruption.

7. The apparatus of claim 1, wherein to identify the last active thread for each sub-wave in the set of sub-waves, the processor is configured to:
identify, in parallel, the last active thread for each sub-wave in the set of sub-waves.

8. The apparatus of claim 7, wherein to identify, in parallel, the last active thread for each sub-wave in the set of sub-waves, the processor is configured to:
identify, in parallel, the last active thread for each sub-wave in the set of sub-waves outside of a loop operation associated with the set of wave operations for each sub-wave in the set of sub-waves.

9. The apparatus of claim 1, wherein to identify the last active thread from amongst the set of threads for each sub-wave in the set of sub-waves, the processor is configured to:
select the last active thread from amongst a plurality of active threads for each sub-wave in the set of sub-waves.

10. The apparatus of claim 9, wherein to select the last active thread from amongst the plurality of active threads for each sub-wave in the set of sub-waves, the processor is configured to:
select, via a get-last multiple operation, the last active thread from amongst the plurality of active threads for each sub-wave in the set of sub-waves.

11. The apparatus of claim 9, wherein the last active thread is a last active fiber, and wherein the plurality of active threads is a plurality of active fibers for each sub-wave in the set of sub-waves.

12. The apparatus of claim 1, wherein each sub-wave in the set of sub-waves corresponds to a cluster, and wherein the cluster includes the set of threads for each sub-wave in the set of sub-waves.

13. The apparatus of claim 12, wherein each of the set of threads in the cluster is associated with at least one of:
a fiber identifier (ID),
a current active mask,
a get-last multiple operation,
a local atomic operation, or
a join point.

14. The apparatus of claim 12, wherein the set of threads in the cluster includes: two (2) threads, four (4) threads, eight (8) threads, sixteen (16) threads, thirty-two (32) threads, or sixty-four (64) threads.

15. The apparatus of claim 1, wherein the processor is further configured to:
obtain an indication of the wave prior to the allocation of the wave into the set of sub-waves, wherein the allocation of the wave into the set of sub-waves is based on the obtained wave.

16. The apparatus of claim 1, wherein the processor is further configured to:
output an indication of the last active thread for each sub-wave in the set of sub-waves.

17. The apparatus of claim 16, wherein the apparatus is a wireless communication device, further comprising at least one of an antenna or a transceiver coupled to the processor, wherein to output the indication of the last active thread for each sub-wave in the set of sub-waves, the processor is configured to:
transmit, to at least one component at a graphics processing unit (GPU) or a central processing unit (CPU) via at least one of the antenna or the transceiver, the indication of the last active thread for each sub-wave in the set of sub-waves.

18. The apparatus of claim 16, wherein to output the indication of the last active thread for each sub-wave in the set of sub-waves, the processor is configured to:
store, in a graphics processing unit (GPU), the indication of the last active thread for each sub-wave in the set of sub-waves.

19. A method of graphics processing, comprising:
allocating a wave into a set of sub-waves, wherein each sub-wave in the set of sub-waves comprises a set of threads;
performing a set of wave operations for each sub-wave in the set of sub-waves; and
identifying, based on the set of wave operations, a last active thread from amongst the set of threads for each sub-wave in the set of sub-waves.

20. A computer-readable medium storing computer executable code for graphics processing, the code when executed by a processor causes the processor to:
allocate a wave into a set of sub-waves, wherein each sub-wave in the set of sub-waves comprises a set of threads;
perform a set of wave operations for each sub-wave in the set of sub-waves; and
identify, based on the set of wave operations, a last active thread from amongst the set of threads for each sub-wave in the set of sub-waves.
